(19) United States
(12) Patent Application Publication
(10) Pub. No.: US 2019/0021118 A1
(43) Pub. Date: Jan. 17, 2019

(54) NARROWBAND RANDOM ACCESS FOR WIRELESS COMMUNICATIONS

(71) Applicant: QUALCOMM Incorporated, San Diego, CA (US)

(72) Inventor: Nir Tishbi, Kfar Saba (IL)

(21) Appl. No.: 15/647,941

(22) Filed: Jul. 12, 2017

(51) Int. Cl. H04W 74/08; H04B 1/713; H04W 72/04; H04W 4/00; H04W 74/00

(52) U.S. Cl. CPC H04W 74/0833; H04B 1/713; H04W 74/004; H04W 4/005; H04W 74/006; H04W 72/0453

(57) ABSTRACT

Methods, systems, and devices for narrowband random access in a wireless communications system are described. A narrowband receiver may be implemented in a base station and may be used to perform low signal to noise ratio (SNR) processing and carrier frequency offset (CFO) cancellation in order to detect or decode an access message transmitted by another wireless device, such as a user equipment (UE). SNR processing and CFO cancellation may involve mapping differential operations to one or more accumulators and computing intra-symbol group averaging for symbols groups. By processing the access message according to the described techniques, the base station may estimate a round trip delay (RTD) time between the base station and the UE.

### BACKGROUND

The following relates generally to wireless communication, and more specifically to narrowband random access for wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

Some wireless devices may communicate using a portion of a frequency spectrum. For example, narrowband communication may include narrowband LTE (NB-LTE) communication, machine to machine (M2M) communication, machine type communication (MTC), and NB-Internet of Things (NB-IoT) communication, among others. In some cases, narrowband communication may be employed in communications over large distances and/or challenging conditions. For example, an MTC device (e.g., a sensor) may be located remotely or in an obstructed location (e.g., a basement). Additionally or alternatively, some devices may be examples of power-limited devices. Such devices may operate in accordance with power constraints, which may in some cases affect throughput for the wireless communications system. Improved techniques for random access may be desired.

### SUMMARY

The described techniques relate to improved methods, systems, devices, or apparatuses that support narrowband random access for wireless communications. Generally, the described techniques provide for a receiver that supports efficient random access procedures. The receiver may be operable to facilitate random access at large ranges and/or in difficult communication scenarios (e.g., low signal to noise ratio (SNR)). In some examples, the receiver may support low SNR processing and/or carrier frequency offset (CFO) cancellation (e.g., in order to facilitate round trip delay (RTD) time estimation). Additionally, in some examples, the receiver may use techniques described herein to support random access detection.

A method of wireless communication is described. The method may include receiving, at a base station from a UE, an access request including an identification of a plurality of sets of symbol groups, performing a set of differential operations for each set of symbol groups, mapping each differential operation to a corresponding accumulator of a plurality of accumulators, and estimating a RTD time between the UE and the base station based at least in part on the mapped differential operations.

An apparatus for wireless communication is described. The apparatus may include means for receiving, at a base station from a UE, an access request including an identification of a plurality of sets of symbol groups, means for performing a set of differential operations for each set of symbol groups, means for mapping each differential operation to a corresponding accumulator of a plurality of accumulators, and means for estimating a RTD time between the UE and the base station based at least in part on the mapped differential operations.

Another apparatus for wireless communication is described. The apparatus may include a processor, memory in electronic communication with the processor, and instructions stored in the memory. The instructions may be operable to cause the processor to receive, at a base station from a UE, an access request including an identification of a plurality of sets of symbol groups, perform a set of differential operations for each set of symbol groups, map each differential operation to a corresponding accumulator of a plurality of accumulators, and estimate a RTD time between the UE and the base station based at least in part on the mapped differential operations.

A non-transitory computer readable medium for wireless communication is described. The non-transitory computer-readable medium may include instructions operable to cause a processor to receive, at a base station from a UE, an access request including an identification of a plurality of sets of symbol groups, perform a set of differential operations for each set of symbol groups, map each differential operation to a corresponding accumulator of a plurality of accumulators, and estimate a RTD time between the UE and the base station based at least in part on the mapped differential operations.

Some examples of the method, apparatus, and non-transitory computer-readable medium described above may further include processes, features, means, or instructions for computing an intra-symbol group average for each symbol group of a set of symbol groups, wherein each differential operation for the set of symbol groups may be mapped based at least in part on intra-symbol group averages of two symbol groups of the set of symbol groups.

Some examples of the method, apparatus, and non-transitory computer-readable medium described above may further include processes, features, means, or instructions for estimating a CFO term based at least in part on the mapped differential operations, wherein the RTD time may be estimated based at least in part on the estimated CFO term.

In some examples of the method, apparatus, and non-transitory computer-readable medium described above, estimating the CFO term comprises performing a fine CFO estimation based at least in part on a differential of a first accumulator of the plurality of accumulators and a second accumulator of the plurality of accumulators.

In some examples of the method, apparatus, and non-transitory computer-readable medium described above, a first differential operation of the set of differential operations may be mapped to one of the first accumulator or the second accumulator based at least in part on an initial tone for a first symbol group of the set of symbols groups. In some examples of the method, apparatus, and non-transitory computer-readable medium described above, a second differential operation of the set of differential operations may be mapped to the other of the first accumulator or the second accumulator based at least in part on the initial tone for the first symbol group of the set of symbols groups.

Some examples of the method, apparatus, and non-transitory computer-readable medium described above may further include processes, features, means, or instructions for performing a coarse offset estimation, wherein a range of unambiguous frequency offsets associated with the fine CFO estimation may be increased based at least in part on the coarse offset estimation.

In some examples of the method, apparatus, and non-transitory computer-readable medium described above, estimating the RTD time comprises frequency correcting each of the plurality of accumulators based at least in part on the estimated CFO term. Some examples of the method, apparatus, and non-transitory computer-readable medium described above may further include processes, features, means, or instructions for dividing the plurality of accumulators into a first group of accumulators and a second group of accumulators, wherein the first group of accumulators conveys a dominant portion of phase information associated with the access request and the second group of accumulators conveys phase disambiguation information. Some examples of the method, apparatus, and non-transitory computer-readable medium described above may further include processes, features, means, or instructions for calculating the RTD time based at least in part on the first group of accumulators and the second group of accumulators.

Some examples of the method, apparatus, and non-transitory computer-readable medium described above may further include processes, features, means, or instructions for comparing a function of the first group of accumulators and the second group of accumulators to a threshold. Some examples of the method, apparatus, and non-transitory computer-readable medium described above may further include processes, features, means, or instructions for detecting a presence of the access request based at least in part on the comparison.

Some examples of the method, apparatus, and non-transitory computer-readable medium described above may further include processes, features, means, or instructions for identifying a sub-carrier index sequence of a set of symbol groups, wherein each differential operation for the set of symbol groups may be mapped based at least in part on the sub-carrier index sequence.

In some examples of the method, apparatus, and non-transitory computer-readable medium described above, each sub-carrier index sequence comprises an initial tone for a first symbol group of the set of symbol groups. In some examples of the method, apparatus, and non-transitory computer-readable medium described above, each sub-carrier index sequence comprises respective tones for each subsequent symbol group of the set of symbol groups, the respective tones being based at least in part on the initial tone and an inner hopping sequence.

In some examples of the method, apparatus, and non-transitory computer-readable medium described above, the initial tone may be based at least in part on a pseudo-random outer hopping sequence.

In some examples of the method, apparatus, and non-transitory computer-readable medium described above, the identification of the plurality of sets of symbol groups comprises a first format of the access request, the first format having a first cyclic prefix (CP) length. In some examples of the method, apparatus, and non-transitory computer-readable medium described above, the identification of the plurality of sets of symbol groups comprises a second format of the access request, the second format having a second CP length longer than the first CP length.

### BRIEF DESCRIPTION OF THE DRAWINGS

FIG. 1 illustrates an example of a system for wireless communication that supports narrowband random access for wireless communications in accordance with aspects of the present disclosure.

FIG. 2 illustrates an example of a wireless communications system that supports narrowband random access for wireless communications in accordance with aspects of the present disclosure.

FIG. 3 illustrates an example of a narrowband transmission scheme that supports narrowband random access for wireless communications in accordance with aspects of the present disclosure.

FIG. 4 illustrates an example of a receiver diagram that supports narrowband random access for wireless communications in accordance with aspects of the present disclosure.

FIGS. 5 through 7 show diagrams of a device that supports narrowband random access for wireless communications in accordance with aspects of the present disclosure.

FIG. 8 illustrates a diagram of a system including a base station that supports narrowband random access for wireless communications in accordance with aspects of the present disclosure.

FIG. 9 illustrates a method for narrowband random access for wireless communications in accordance with aspects of the present disclosure.

### DETAILED DESCRIPTION

Some wireless communications systems may support the use of various signals. For example, narrowband signals may limit the bandwidth over which a given device is operable to monitor for transmissions to be received or modulate transmissions to be sent. Such considerations may support power-efficient operations of the device or otherwise benefit the wireless communications system. However, in some cases such power limited devices (e.g., or non-power-limited devices that are operable to communicate over a portion of a spectrum, such as a narrowband portion) may experience difficult communication environments. For example, such devices may be located remotely relative to a network node (e.g., a base station) or communications originating at such devices may experience significant signal attenuation (e.g., due to various obstructions, interference from other transmissions, etc.).

In some cases, devices (e.g., narrowband-capable devices) may periodically enter a power-saving mode (e.g., to conserve power when data is not being actively transmitted). In order to resume communications with the network node after entering the power save mode (e.g., or in order to initiate communications with a new network node), the device may participate in a random access procedure. The random access procedure may allow the network node and device to identify one or more important communication parameters (e.g., an RTD time, a SNR estimate, a CFO). In accordance with techniques described herein, a receiver at a network node (e.g., a base station) may be operable to support efficient random access procedures through processing of low SNR signals, efficient CFO cancellation, and accurate RTD estimation.

Aspects of the disclosure are initially described in the context of a wireless communications system. Aspects of the disclosure are then described in the context of transmission schemes, message formats, and process flows that support narrowband random access. Aspects of the disclosure are further illustrated by and described with reference to apparatus diagrams, system diagrams, and flowcharts that relate to narrowband random access for wireless communications. In some examples, a receiver is described as being or including a narrowband receiver, but the present techniques are not limited to this application.

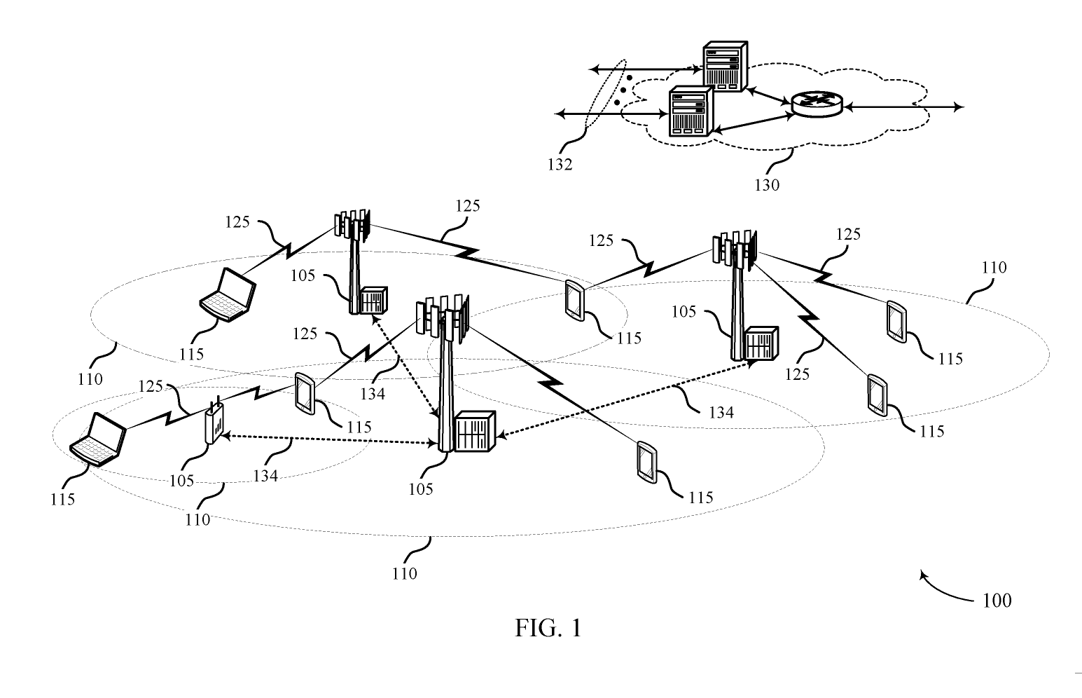

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE network, LTE-Advanced (LTE-A) network, or an NR network. In some cases, wireless communications system 100 may support enhanced broadband communications, ultra-reliable (i.e., mission critical) communications, low latency communications, and communications with low-cost and low-complexity devices. Wireless communications system 100 may support narrowband random access for wireless communications.

Base stations 105 may wirelessly communicate with UEs 115 via one or more base station antennas. Each base station 105 may provide communication coverage for a respective geographic coverage area 110. Communication links 125 shown in wireless communications system 100 may include uplink transmissions from a UE 115 to a base station 105, or downlink transmissions, from a base station 105 to a UE 115. Control information and data may be multiplexed on an uplink channel or downlink according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as evolved NodeBs (eNBs) 105.

UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of Things (IoT) device, an Internet of Everything (IoE) device, an MTC device, an appliance, an automobile, or the like.

Wireless communications system 100 may operate in an ultra-high frequency (UHF) frequency region using frequency bands from 700 MHz to 2600 MHz (2.6 GHz), although some networks (e.g., a wireless local area network (WLAN)) may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communications system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g., a base station 105) to shape and/or steer an overall antenna beam in the direction of a target receiver (e.g., a UE 115). This may be achieved by combining elements in an antenna array in such a way that transmitted signals at particular angles experience constructive interference while others experience destructive interference.

Multiple-input multiple-output (MIMO) wireless systems use a transmission scheme between a transmitter (e.g., a base station 105) and a receiver (e.g., a UE 115), where both transmitter and receiver are equipped with multiple antennas. Some portions of wireless communications system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may multiple use antennas or antenna arrays to conduct beamforming operations for directional communications with a UE 115.

In some cases, wireless system 100 may utilize both licensed and unlicensed radio frequency spectrum bands. For example, wireless system 100 may employ LTE License Assisted Access (LTE-LAA) or LTE Unlicensed (LTE U) radio access technology or NR technology in an unlicensed band such as the 5 GHz Industrial, Scientific, and Medical (ISM) band. When operating in unlicensed radio frequency spectrum bands, wireless devices such as base stations 105 and UEs 115 may employ listen-before-talk (LBT) procedures to ensure the channel is clear before transmitting data. In some cases, operations in unlicensed bands may be based on a CA configuration in conjunction with CCs operating in a licensed band. Operations in unlicensed spectrum may include downlink transmissions, uplink transmissions, or both. Duplexing in unlicensed spectrum may be based on frequency division duplexing (FDD), time division duplexing (TDD) or a combination of both.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” and “channel” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced component carriers (eCCs). An eCC may be characterized by one or more features including: wider bandwidth, shorter symbol duration, shorter TTIs, and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz, etc.) at reduced symbol durations (e.g., 16.67 microseconds). A TTI in eCC may consist of one or multiple symbols. In some cases, the TTI duration (that is, the number of symbols in a TTI) may be variable.

A shared radio frequency spectrum band may be utilized in an NR shared spectrum system. For example, an NR shared spectrum may utilize any combination of licensed, shared, and unlicensed spectrums, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

In some cases, a UE 115 may also be able to communicate directly with other UEs (e.g., using a peer-to-peer (P2P) or device-to-device (D2D) protocol). One or more of a group of UEs 115 utilizing D2D communications may be within the coverage area 110 of a cell. Other UEs 115 in such a group may be outside the coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Some UEs 115, such as MTC or IoT devices, may be low cost or low complexity devices, and may provide for automated communication between machines, i.e., M2M communication. M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, an MTC device may operate using half-duplex (one-way) communications at a reduced peak rate. MTC devices may also be configured to enter a power saving “deep sleep” mode when not engaging in active communications. In some cases, MTC or IoT devices may be designed to support mission critical functions and wireless communications system may be configured to provide ultra-reliable communications for these functions.

Wireless communications system 100 may use multiple channels, such as logical channels, transport channels, and physical layer channels, to communicate data. For example, uplink physical channels may include physical random access channel (PRACH) for access messages. The PRACH may be allocated time and frequency resources during which UEs 115 may initiate communication with the wireless communications system 100 without prior scheduling.

In some cases, a wireless communications system 100 may utilize both LTE and narrowband radio access technologies. In some examples, narrowband communications may be used to serve MTC devices. Narrowband communications may use limited frequency resources, and, in some cases, may be limited to a single RB of system bandwidth (e.g., 180 kHz), a series of RBs, or portions of an RB. In some examples, the frequency resources set aside for narrowband communications may be located within an LTE carrier, in a guard band of an LTE carrier, or separate from an LTE carrier in a “standalone” deployment. In some cases, the narrowband resources may be simultaneously utilized by multiple UEs 115. The narrowband resources may be used to provide deep coverage to support devices in environments that are associated with different coverage enhancement levels. For instance, certain stationary devices may be located in environments with poor coverage, such as a basement. Additionally, the narrowband resources may be associated with communications within a large coverage area 110. Communications to a device at an edge of the coverage area 110 may have a large delay (e.g., 200 s) in comparison to an LTE symbol time (e.g., 72 is).

In some cases, wireless communications system 100 may utilize coverage enhancement techniques with narrowband communications to improve the quality of a communication link 125 for UEs 115 located at a cell edge, operating with low power transceivers, or experiencing high interference or path loss. Coverage enhancement techniques may include repeated transmissions, beamforming, power boosting, or other techniques. The coverage enhancement techniques used may depend on the specific needs of UEs 115 in different circumstances, and may be effective for communicating with devices that are located in areas that routinely experience poor channel conditions.

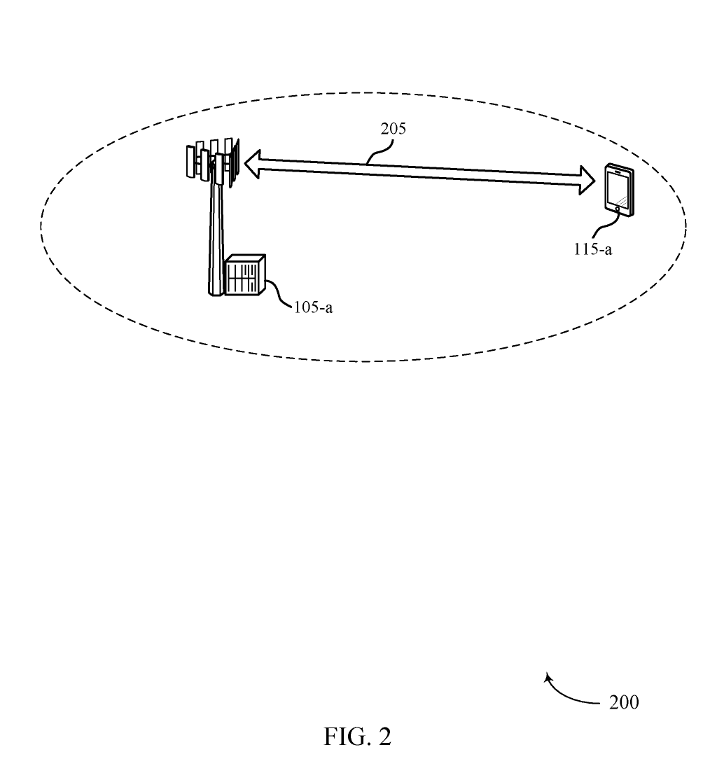

FIG. 2 illustrates an example of a wireless communications system 200 that supports narrowband random access for wireless communications in accordance with various aspects of the present disclosure. In some examples, wireless communications system 200 may implement aspects of wireless communication system 100. Wireless communications system 200 includes a base station 105-a and UE 115-a, each of which may be an example of the corresponding device described above with reference to FIG. 1.

UE 115-a may be an example of a narrowband-capable device (e.g., an MTC device) that is operable to communicate with base station 105-a over a narrowband wireless link 205, which may be an example of a communication link 125 as described with reference to FIG. 1. In some cases, communications over narrowband wireless link 205 may be impacted by a distance between UE 115-a and base station 105-a, signal attenuation due to obstacles between UE 115-a and base station 105-a, signal interference due to other transmissions in wireless communications system 200, etc.

Accordingly, base station 105-a may contain a receiver (e.g., a narrowband receiver) as described herein (or components thereof) to support communications with UE 115-a. In some examples, narrowband wireless link 205 may support narrowband PRACH (NPRACH) transmissions. For example, UE 115-a may transmit an access message using NPRACH resources over narrowband wireless link 205 (e.g., in order to initiate an exchange of data with base station 105-a).

In accordance with aspects of the present disclosure, base station 105-a may perform low SNR processing and CFO cancellation in order to detect and/or decode the access message. Based on processing the access message, base station 105-a may estimate a RTD time between itself and UE 115-a (e.g., which may in turn be used to facilitate data transfer between the devices).

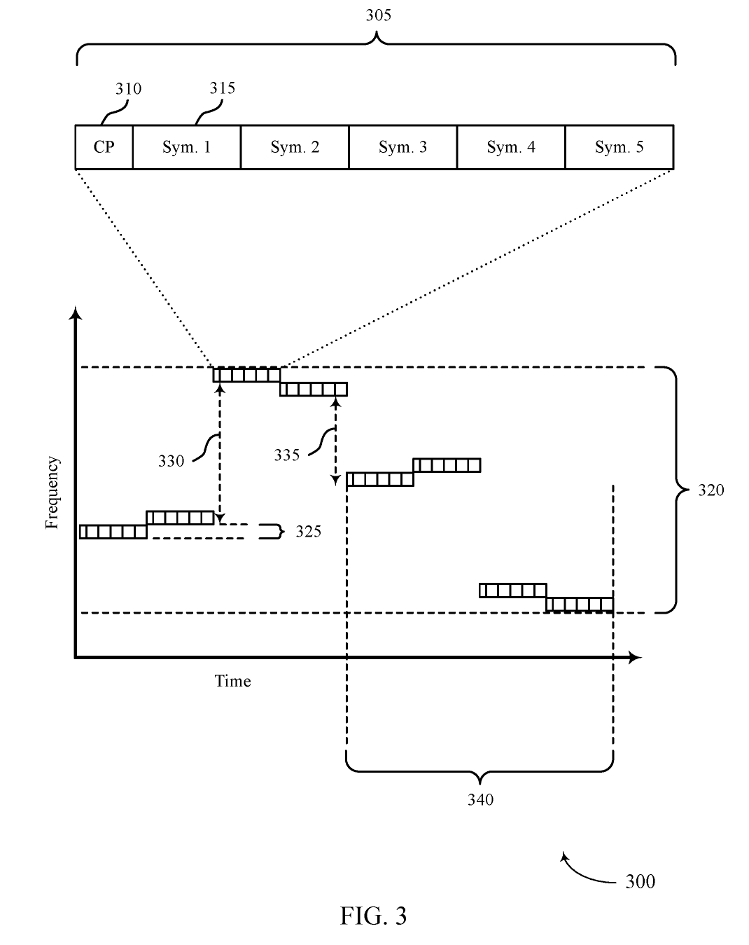

FIG. 3 illustrates an example of a narrowband transmission scheme 300 that supports narrowband random access for wireless communications in accordance with various aspects of the present disclosure. In some examples, narrowband transmission scheme 300 may implement aspects of wireless communications systems 100 or 200 as described with reference to FIGS. 1 and 2. Narrowband transmission scheme 300 may be performed between a base station 105 and UE 115 as described above (e.g., may be performed over a narrowband wireless link 205 as described with reference to FIG. 2). Accordingly, aspects of transmission scheme 300 are described in the context of a NPRACH transmission.

The NPRACH design is based on 3.75 kHz single-tone hopping and may enable random access message detection along with RTD estimation at sufficient accuracy to enable subsequent narrowband physical uplink shared channel (NPUSCH) and/or narrowband physical downlink shared channel (NPDSCH) communications (e.g., under a Maximal Coupling Loss (MCL) of 164 dB). By way of example, RTD estimation with sufficient accuracy may include RTD estimation within 3.646 is.

In some examples, each NPRACH opportunity (i.e., which may refer to a set of time-frequency resources over which a random access message may be transmitted) within an NPRACH resource may contain twelve (12) sub-carriers spanning up to 128 repetitions (e.g., spanning around 800 ms). The twelve (12) subcarriers may span a narrowband portion 320 of a frequency spectrum. Each tone of the NPRACH resource may be transmitted across five (5) contiguous (i.e., contiguous in time) symbols 315 preceded by CP 310. Each collection of contiguous symbols 315 and the respective CP 310 may be referred to as a symbol group 305 in aspects of the present disclosure.

In some cases, a wireless communications system may support two (2) NPRACH formats, where each format may be associated with a different CP length. The CP length may provide an upper bound on the maximum range between communicating devices that can be supported. By way of example, a first format (i.e., Format 0) may employ a CP length of 66.66 s and support a maximum range of around 10 km. A second format (i.e., Format 1) may employ a CP length of 266.66 s and support a maximum range of around 40 km.

Tone-hopping may occur between symbol groups 305 and may consist of two levels of hopping. The first hopping level (e.g., which may be referred to as inner hopping) may comprise frequency hops of 3.75 kHz (i.e., frequency hop 325) or 22.5 kHz (i.e., frequency hop 320). The second hopping level (e.g., which may be referred to as outer hopping) may comprise frequency hops 335 dictated by a pseudo-random sequence.

Inner hopping may occur within a period of four symbol groups 305, which may constitute a basic NPRACH unit 340. Outer hopping may occur across repetitions (i.e., between NPRACH units 340) and may be based on a pseudo-random sequence (e.g., a sequence that varies according to a given cell identifier (ID)).

In some cases, narrowband transmission scheme 300 may support various performance requirements. For example, the maximum permissible UE frequency error may be bounded based at least in part on the BS carrier frequency. By way of example, if the carrier frequency is greater than or equal to 1 GHz, the maximum permissible UE frequency error may be +0.2 parts per million (ppm); if the carrier frequency is less than or equal to 1 GHz, the maximum permissible UE frequency error may be +0.1 ppm. For example, considering a maximum carrier frequency of 2.3 GHz, the maximum permissible UE frequency error (i.e., maximum frequency offset) may be 230 Hz.

In some cases a maximum false alarm rate P_{FA} may be restricted to being lower than 0.1%. The false alarm rate may refer to the fraction of detected signals at a receiver that are incorrectly classified as valid transmissions. Similarly, in some cases the missed detection rate (i.e., the number of access messages that are not detected by the receiver) may be required to be lower than 1%. In some cases, a missed detection event may be declared when the access message is not detected or the RTD error is greater than some allowed maximum (e.g., 3.646 μs). In some cases, the maximum cell radius supported for NPRACH transmissions may be 35 km.

It is to be understood that the numbers above are included for the sake of explanation and are not limiting of scope. Accordingly, the described techniques may be employed in wireless communications systems supporting different performance requirements.

Similarly, example equations considered in designing a narrowband receiver that supports narrowband random access are described below. In some cases, similar equations or techniques may be employed to achieve the same results as various of the equations below. Thus, it is to be understood that the example equations are included for explanatory purposes and are not necessarily limiting of scope. In designing a narrowband receiver that supports narrowband random access, various mathematical models may be employed.

By way of example, the m^{th} symbol (e.g., where 0≤m≤N−1) transmitted on the u^{th} NPRACH opportunity (e.g., with 1≤u≤U) on the g^{th} symbol group (e.g., with 0≤g≤N_{g}−1) at the r^{th} repetition (e.g., with 0≤r≤R−1) may be modeled as:

$$\begin{matrix}{x}_{m , u , g , r} ( t ) = {( - 1 )}^{m} {β}_{u} {e}^{j \frac{2 π}{T} ( k ( u , g , r ) + \frac{1}{2} ) t} {e}^{j2 π {f}_{u} ( t + {t}_{d} ( m , g , r ) )} {e}^{j {φ}_{u} ( t + {t}_{d} ( m , g , r ) )} , 0 \leq t < T \\ where & ( 1 ) \\ {t}_{d} ( m , g , r ) = ( {T}_{CP} + {N}_{s} T ) ( {rN}_{G} + g ) + {T}_{CP} + mT & ( 2 )\end{matrix}$$

In these equations:

$$T = \frac{1}{Δ f}$$

is the sub-carrier spacing; βᵤ is the transmit gain of the u^{th} NPRACH transmission; Nₛ is the number of symbols 315 (e.g., 5) in a symbol group 305 (excluding the CP 310); N_{g} is the number of symbol groups in a basic NPRACH unit 340 (e.g., 4); fᵤ is the u^{th} UE frequency offset; ϕₙ(t) is the u^{th} UE phase-noise (e.g., where ϕₙ(0)=ϕ_{u,0}); and k(u,g,r) is the NPRACH sub-carrier index at the specified opportunity. The time-index t in Eq. 1 is referenced to the UE time grid.

The corresponding continuous-time received symbol at the i^{th} antenna port of a base station 105 may be modeled as:

$${y}_{m , g , r}^{( i )} ( t ) = {\sum }_{u = 1}^{U} {{H}_{u , m , g , r}^{( i )} ( - 1 )}^{m} {β}_{u} {e}^{j \frac{2 π}{T} ( k ( u , g , r ) + \frac{1}{2} ) ( t - {τ}_{u} )} {e}^{j2 π {f}_{u} ( t - {τ}_{u} + {t}_{d} ( m , g , r ) ) + {Φ}^{( i )}} {e}^{j {φ}_{u} ( t - {τ}_{u} + {t}_{d} ( m , g , r ) )} + {w}_{m , g , r}^{( i )} ( t ) , 0 \leq t < T \qquad ( 3 )$$

where:
H_{n,m,g,r}^{(t)} is the channel response from the u^{th} UE to the i^{th} antenna;

E[|w_{m,g,r}⁽ⁱ⁾(t)|²]=σ_{w}²;

Φ^{[j]} is the unknown demodulation phase of the i^{th} antenna; and
the time-index t is now referenced to the base station 105-a time-grid. The equivalent discrete-time signal, obtained by sampling the continuous-time signal at rate Fₛ may in turn be represented by:

$${y}_{m , g , r}^{( i )} [ n ] = {\sum }_{u = 1}^{U} {{H}_{u , m , g , r}^{( i )} ( - 1 )}^{m} {β}_{u} {e}^{j \frac{2 π}{N} ( k ( u , g , r ) + \frac{1}{2} ) ( n - {τ}_{u} {F}_{s} )} {e}^{j2 π \frac{{f}_{u}}{{F}_{s}} ( n - {τ}_{u} {F}_{s} + {t}_{d} ( m , g , r ) {F}_{s} ) + {Φ}^{( i )}} {e}^{j {φ}_{u} ( \frac{n}{{F}_{s}} - {τ}_{u} + {t}_{d} ( m , g , r ) )} + {w}_{m , g , r}^{( i )} [ n ] , 0 \leq n < N \qquad ( 4 )$$

where

$$N = \frac{{F}_{s}}{Δ f} .$$

Following half subcarrier (SC) shift removal, the signal at the discrete Fourier transform (DFT) input may be represented by:

$${z}_{m , g , r}^{( i )} [ n ] = {\sum }_{u = 1}^{U} {H}_{u , m , g , r}^{( i )} {β}_{u} {e}^{j \frac{2 π}{N} k ( u , g , r ) ( n - {τ}_{u} {F}_{s} )} {e}^{j 2 π \frac{{f}_{u}}{{F}_{s}} ( n - {τ}_{u} {F}_{s} + {t}_{d} ( m , g , r ) {F}_{s} )} {e}^{j {\overline{φ}}_{u}^{( i )} ( \frac{n}{{F}_{s}} - {τ}_{u} + {t}_{d} ( m , g , r ) )} + {w}_{m , g , r}^{( i )} [ n ] , 0 \leq n < N \qquad ( 5 )$$

where \tilde{ϕ}ᵤ(t)=ϕᵤ(t)+Φ⁽ⁱ⁾−½τᵤFₛ;

In some cases the communication channel may be modeled using a channel impulse response comprising discrete taps, each of which may be an independent Gaussian random variable (RV). Accordingly, each channel frequency response may be modeled as a Gaussian RV. With respect to channel fading characteristics, the Doppler spread encountered in a narrowband communication link may be approximately 5 Hz. Consequently, under classic Doppler models (e.g., Jakes' Model), the channel may be assumed to be relatively constant across a single NPRACH unit 340. Moreover, under typical propagation conditions, the channel may be relatively constant across narrowband portion 320.

The received signal may be represented by:

$${z}_{m , g , r}^{( i )} [ n ] = {\sum }_{u = 1}^{U} {H}_{u , m , g , r}^{( i )} {β}_{u} {e}^{j \frac{2 π}{N} k ( u , g , r ) ( n - {τ}_{u} {F}_{s} )} {e}^{j 2 π \frac{{f}_{u}}{{F}_{s}} ( n - {τ}_{u} {F}_{s} + {t}_{d} ( m , g , r ) {F}_{s} )} {e}^{j {\overline{φ}}_{u}^{( i )} ( \frac{n}{{F}_{s}} - {τ}_{u} + {t}_{d} ( m , g , r ) )} + {w}_{m , g , r}^{( i )} [ n ] , 0 \leq n < N \qquad ( 6 )$$

In some cases, phase-noise may vary slowly (e.g., such that it is approximately constant over a duration of a NPRACH unit 340) such that:

\tilde{ϕ}ᵤ⁽ⁱ⁾(t)=\tilde{ϕ}_{u,r}⁽ⁱ⁾ (7)

Accordingly, Eq. 6 may be rewritten as:

$$\begin{matrix}{z}_{m , g , r}^{( i )} [ n ] = {\sum }_{u = 1}^{U} {H}_{u , m , g , r}^{( i )} {B}_{u , r}^{( i )} {e}^{j \frac{2 π}{N} k ( u , g , r ) ( n - {τ}_{u} {F}_{s} )} {e}^{j 2 π \frac{{f}_{u}}{{F}_{s}} ( n - {τ}_{u} {F}_{s} + {t}_{d} ( m , g , r ) {F}_{s} )} + {w}_{m , g , r}^{( i )} [ n ] , 0 \leq n < N \\ where : & ( 8 ) \\ {B}_{u , r}^{( i )} = {β}_{u} {e}^{j {\tilde{Φ}}_{u , r}^{( i )}} & ( 9 ) \\ {\tilde{Φ}}_{u , r}^{( i )} = {\tilde{φ}}_{u , r}^{( i )} - 2 π {f}_{u} {τ}_{u} & ( 10 )\end{matrix}$$

Applying an N-point DFT yields:

$${Z}_{m , g , r}^{( i )} [ l ] = {\sum }_{u = 1}^{U} {H}_{u , m , g , r}^{( i )} {B}_{u , r}^{( i )} {\sum }_{n = 0}^{N - 1} {e}^{j \frac{2 π}{N} k ( u , g , r ) ( n - {τ}_{u} {F}_{s} )} {e}^{j 2 π \frac{{f}_{u}}{{F}_{s}} ( n + {t}_{d} ( m , g , r ) {F}_{s} )} {e}^{- j \frac{2 π}{N} l \cdot n} + {\tilde{w}}_{m , g , r}^{( i )} [ l ] , 0 \leq l < N \\ where \text{:} E \{ {\vert {\tilde{w}}_{m , g , r}^{( i )} [ l ] \vert}^{2} \} = N {σ}_{w}^{2} . \qquad ( 11 )$$

Expanding Eq. 11 yields:

$${Z}_{m , g , r}^{( i )} [ l ] = {\sum }_{u = 1}^{U} {H}_{u , m , g , r}^{( i )} {B}_{u , r}^{( i )} {e}^{- j \frac{2 π}{N} k ( u , g , r ) {τ}_{u} {F}_{s}} {e}^{j 2 π {f}_{u} {t}_{d} ( m , g , r )} {\sum }_{n = 0}^{N - 1} {e}^{j \frac{2 π}{N} k ( u , g , r ) n} {e}^{j 2 π \frac{{f}_{u}}{{F}_{s}} n} {e}^{- j \frac{2 π}{N} l \cdot n} + {\tilde{w}}_{m , g , r}^{( i )} [ l ] , 0 \leq l < N \qquad ( 12 )$$

In some cases, (e.g., if u=u₀ such that I_{g,r}=k(u₀,g,r) for all g,r):

$${Z}_{m , g , r}^{( i )} [ {l}_{g , r} ] = {H}_{{u}_{0} , m , g , r}^{( i )} {B}_{{u}_{0} , r}^{( i )} {e}^{- j \frac{2 π}{N} {l}_{g , r} {τ}_{{u}_{0}} {F}_{s}} {e}^{j 2 π {f}_{{u}_{0}} {t}_{d} ( m , g , r )} {\sum }_{n = 0}^{N - 1} {e}^{j 2 π \frac{{f}_{{u}_{0}}}{{F}_{s}} n} + {\sum }_{u \neq {u}_{0}} {H}_{u , m , g , r}^{( i )} {B}_{u , r}^{( i )} {e}^{- j \frac{2 π}{N} k ( u , g , r ) {τ}_{u} {F}_{s}} {e}^{j 2 π {f}_{u} {t}_{d} ( m , g , r )} {\sum }_{n = 0}^{N - 1} {e}^{j \frac{2 π}{N} ( k ( u , g , r ) + \frac{{f}_{u}}{Δ f} - {l}_{g , r} ) n} + {\tilde{w}}_{m , g , r}^{( i )} [ l ] , 0 \leq l < N \qquad ( 13 )$$

In some cases (e.g., in order to improve the SNR prior to carrying out the RTD estimation) we average over all the symbols within a symbol group. The resulting signal is given by:

$${M}_{g , r}^{( i )} [ {l}_{g , r} ] = \frac{1}{N} {\sum }_{m = 0}^{{N}_{s} - 1} {Z}_{m , g , r}^{( i )} [ {l}_{g , r} ] = \frac{1}{{N}_{s}} {H}_{{u}_{0} , r}^{( i )} {B}_{{u}_{0} , r}^{( i )} {e}^{- j 2 π Δ f \cdot {l}_{g , r} {τ}_{{u}_{0}}} \frac{1 - {e}^{j 2 π \frac{{f}_{u} 0}{{F}_{s}} N}}{1 - {e}^{j 2 π \frac{{f}_{u 0}}{{F}_{s}}}} {\sum }_{m = 0}^{{N}_{s} - 1} {e}^{j 2 π {f}_{{u}_{0}} {t}_{d} ( m , g , r )} + \frac{1}{{N}_{s}} {\sum }_{u \neq {u}_{0}} {H}_{u , r}^{( i )} {B}_{u , r}^{( i )} {e}^{- j 2 π Δ f \cdot k ( u , g , r ) {τ}_{u}} {\sum }_{n = 0}^{N - 1} {e}^{j \frac{2 π}{N} ( k ( u , g , r ) + \frac{{f}_{u}}{Δ f} - {l}_{g , r} ) n} {\sum }_{m = 0}^{{N}_{s} - 1} {e}^{j 2 π {f}_{u} {t}_{d} ( m , g , r )} + {\overline{w}}_{g , r}^{( i )} [ {l}_{g , r} ] \\ where \{ {\vert {w}_{g , r}^{( i )} [ l ] \vert}^{2} \} = \frac{N}{{N}_{s}} {σ}_{w}^{2} \qquad ( 14 )$$

Substituting Eq. 2 into Eq. 14 and further developing the expression yields:

$$\begin{matrix}{M}_{g , r}^{( i )} [ {l}_{g , r} ] = {H}_{{u}_{0} , r}^{( i )} {B}_{{u}_{0} , r}^{( i )} \tilde{N} {e}^{- j 2 π Δ f \cdot {l}_{g , r} {τ}_{{u}_{0}}} {e}^{j {θ}_{g , r}} + \frac{1}{{N}_{s}} {\sum }_{u \neq {u}_{0}} ( 1 - {e}^{j 2 π \frac{{f}_{u}}{Δ f}} ) {H}_{u , r}^{( i )} {B}_{u , r}^{( i )} {e}^{- j 2 π Δ f \cdot k ( u , g , r ) {τ}_{u}} \frac{{\sum }_{m = 0}^{{N}_{s} - 1} {e}^{j 2 π {f}_{u} {t}_{d} ( m , g , r )}}{1 - {e}^{j \frac{2 π}{N} ( k ( u , g , r ) + \frac{{f}_{u}}{Δ f} - {l}_{g , r} )}} + {\overline{w}}_{g , r}^{( i )} [ {l}_{g , r} ] where \text{:} & ( 15 ) \\ \tilde{N} {=}^{Δ} \frac{1}{{N}_{s}} \frac{sin ( π \frac{{f}_{{u}_{0}}}{{F}_{s}} N )}{sin ( π \frac{{f}_{{u}_{0}}}{{F}_{s}} )} \frac{sin ( π \frac{{f}_{{u}_{0}}}{Δ f} {N}_{s} )}{sin ( π \frac{{f}_{{u}_{0}}}{Δ f} )} = N \cdot {D}_{N} ( 2 π \frac{{f}_{{u}_{0}}}{{F}_{s}} ) {D}_{{N}_{s}} ( 2 π \frac{{f}_{{u}_{0}}}{Δ f} ) & ( 16 ) \\ {θ}_{g , r} = 2 π {f}_{{u}_{0}} [ \frac{{N}_{s}}{2 Δ f} - \frac{1}{2 {F}_{s}} + ( {T}_{CP} + {N}_{s} T ) [ ( r - 1 ) {N}_{G} + g - 1 ] + {T}_{CP} - T ] & ( 17 )\end{matrix}$$

where: D_{N}(x) is the Dirichlet function with parameter N

In some cases (e.g., such that fᵤ<<Δf for all u), Eq. 15 may be simplified as:

$${M}_{g , r}^{( i )} [ {l}_{g , r} ] \approx {H}_{{u}_{0} , r}^{( i )} {B}_{{u}_{0} , r}^{( i )} \tilde{N} {e}^{- j 2 π Δ f \cdot {l}_{g , r} {τ}_{{u}_{0}}} {e}^{j {θ}_{g , r}} + {\overline{w}}_{g , r}^{( i )} [ {l}_{g , r} ] \qquad ( 18 )$$

The sequence I_{g,r} satisfies the following relations:

l_{1,r}−l_{0,r}=±1 (19)

l_{3,r}−l_{2,r}=∓1 (20)

as well as:

l_{2,r}−l_{1,r}=±6 (21)

l_{3,r}−l_{0,r}=±6 (22)

where the exact signs of the differences may dependent on the hopping sequence, as described above with reference to the inner hopping pattern (i.e., frequency hop 320 and frequency hop 325).

In some cases, multiplying the result of Eq. 18 of any two symbol groups 305 may compensate for (e.g., remove) the dependence on the subcarrier index and on the channel phase. Carrying out the multiplication for all combinations having a constant phase (i.e., up to sign inversion) yields:

$$\begin{matrix}{D}_{01 , r}^{( i )} = {M}_{0 , r}^{( i )} [ {l}_{0 , r} ] {{M}_{1 , r}^{( i )} [ {l}_{1 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot {τ}_{{u}_{0}}} {e}^{j ( {θ}_{0 , r} - {θ}_{1 , r} )} + {E}_{01 , r}^{( i )} & ( 23 ) \\ {D}_{32 , r}^{( i )} = {M}_{3 , r}^{( i )} [ {l}_{3 , r} ] {{M}_{2 , r}^{( i )} [ {l}_{2 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot {τ}_{{u}_{0}}} {e}^{j ( {θ}_{3 , r} - {θ}_{2 , r} )} + {E}_{32 , r}^{( i )} \\ Similarly : & ( 24 ) \\ {D}_{12 , r}^{( i )} = {M}_{1 , r}^{( i )} [ {l}_{1 , r} ] {{M}_{2 , r}^{( i )} [ {l}_{2 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot 6 {τ}_{{u}_{0}}} {e}^{j ( {θ}_{1 , r} - {θ}_{2 , r} )} + {E}_{12 , r}^{( i )} & ( 25 ) \\ {D}_{03 , r}^{( i )} = {M}_{0 , r}^{( i )} [ {l}_{1 , r} ] {{M}_{3 , r}^{( i )} [ {l}_{4 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot 6 {τ}_{{u}_{0}}} {e}^{j ( {θ}_{0 , r} - {θ}_{3 , r} )} + {E}_{03 , r}^{( i )} & ( 26 )\end{matrix}$$

where E_{q,r}⁽ⁱ⁾ denotes the error due to noise. The signs of the RTD phases are uncorrelated between Eq. 23-24 and Eq. 25-26. Rearranging Eq. 17:

θ_{i,r}−θ_{i-1,r}=2πkfᵤ_{₀}(T_{CP}+NₛT)∀k∈

[symbol]

Thus, Eq. 23-24 and Eq. 25-26 may be rewritten as:

$$\begin{matrix}{D}_{01 , r}^{( i )} = {M}_{0 , r}^{( i )} [ {l}_{0 , r} ] {{M}_{1 , r}^{( i )} [ {l}_{1 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot {τ}_{{u}_{0}}} {e}^{- j Δθ} + {E}_{01 , r}^{( i )} & ( 28 ) \\ {D}_{32 , r}^{( i )} = {M}_{3 , r}^{( i )} [ {l}_{3 , r} ] {{M}_{2 , r}^{( i )} [ {l}_{2 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot {τ}_{{u}_{0}}} {e}^{j Δθ} + {E}_{32 , r}^{( i )} & ( 29 ) \\ {D}_{12 , r}^{( i )} = {M}_{1 , r}^{( i )} [ {l}_{1 , r} ] {{M}_{2 , r}^{( i )} [ {l}_{2 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot 6 {τ}_{{u}_{0}}} {e}^{- j Δθ} + {E}_{12 , r}^{( i )} & ( 30 ) \\ {D}_{03 , r}^{( i )} = {M}_{0 , r}^{( i )} [ {l}_{1 , r} ] {{M}_{3 , r}^{( i )} [ {l}_{2 , r} ]}^{*} = {\tilde{N}}^{2} {\vert {H}_{{u}_{0} , r}^{( i )} \vert}^{2} {\vert {B}_{{u}_{0} , r}^{( i )} \vert}^{2} {e}^{\pm j 2 π Δ f \cdot 6 {τ}_{{u}_{0}}} {e}^{- j 3 Δθ} + {E}_{03 , r}^{( i )} where \text{:} & ( 31 ) \\ Δ θ {=}^{Δ} 2 π {f}_{{u}_{0}} ( {T}_{CP} + {N}_{s} T ) = 2 π \frac{{f}_{{u}_{2}}}{Δ f} ( ɛ + {N}_{s} ) & ( 32 ) \\ ɛ {=}^{Δ} \frac{{T}_{CP}}{T} & ( 33 )\end{matrix}$$

We note that Eq. 28-31 depend on the repetition index r only through the magnitude of the channel response |Hᵤ_{₀}_{,r}⁽ⁱ⁾|². Since the differential operations eliminated the channel phase, all the terms may be in-phase and can therefore be combined across the full span of the repetitions. However, since the sign of the phase associated with the RTD toggles pseudo-randomly (e.g., frequency hop 335), considerations may be taken in order to maximize the processing gain.

As described above, the sign of the RTD phase in Eq. 28-29 is dependent on the evenness/oddness of the first symbol group index within each NPRACH unit 340 (which may alternatively be referred to as a repetition in aspects of the present disclosure). Since the A6 terms in Eq. 28-29 may oppose each other, each of these two equations may be combined across the full span of the repetitions by conjugating and swapping their terms according to:

$$\begin{matrix}{s}_{1 , r} = {s}_{1 , r - 1} + \{ \begin{matrix}{D}_{01 , r}^{( 1 )} + {D}_{01 , r}^{( 2 )} & {l}_{0 , r} even \\ {( {D}_{32 , r}^{( 1 )} + {D}_{32 , r}^{( 2 )} )}^{*} & {l}_{0 , r} odd\end{matrix} & ( 34 ) \\ {s}_{2 , r} = {s}_{2 , r - 1} + \{ \begin{matrix}{D}_{32 , r}^{( 1 )} + {D}_{32 , r}^{( 2 )} & {l}_{0 , r} even \\ {( {D}_{01 , r}^{( 1 )} + {D}_{01 , r}^{( 2 )} )}^{*} & {l}_{0 , r} odd\end{matrix} & ( 35 )\end{matrix}$$

where s_{1,-1}=s_{2,-1}=0.

Since the same relation for AO does not hold in Eq. 30-31, this technique may not apply to these equations. Thus, in some cases, Δθ may be removed from these equations (e.g., using CFO cancellation as described below) before combining conjugating and swapping their terms. For example, removal of Δθ may be facilitated by holding two (2) pairs of accumulators, where at each repetition only a single accumulator in each pair gets updated, based on the sub-carrier index of the second symbol group:

$$\begin{matrix}\{ \begin{matrix}{s}_{3 , r} = {s}_{3 , r - 1} + {D}_{12 , r}^{( 1 )} + {D}_{12 , r}^{( 2 )} & {l}_{1 , r} < 6 \\ {s}_{5 , r} = {s}_{5 , r - 1} + {D}_{12 , r}^{( 1 )} + {D}_{12 , r}^{( 2 )} & {l}_{1 , r} \geq 6\end{matrix} & ( 36 ) \\ \{ \begin{matrix}{s}_{4 , r} = {s}_{4 , r - 1} + {D}_{03 , r}^{( 1 )} + {D}_{03 , r}^{( 2 )} & {l}_{1 , r} < 6 \\ {s}_{6 , r} = {s}_{6 , r - 1} + {D}_{03 , r}^{( 1 )} + {D}_{03 , r}^{( 2 )} & {l}_{1 , r} \geq 6\end{matrix} & ( 37 )\end{matrix}$$

where s_{3,-1}=s_{4,-1}=s_{5,-1}=s_{6,-1}=0. The combining result across all repetitions may be represented as:

$$\begin{matrix}{s}_{1} = {s}_{1 , R - 1} = {\tilde{N}}^{2} ( {\sum }_{r = 0}^{R - 1} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{j 2 π Δ f \cdot {τ}_{{u}_{0}}} {e}^{- j Δ θ} + {E}_{1} & ( 38 ) \\ {s}_{2} = {s}_{2 , R - 1} = {\tilde{N}}^{2} ( {\sum }_{r = 0}^{R - 1} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{j 2 π Δ f \cdot {τ}_{{u}_{0}}} {e}^{j Δ θ} + {E}_{2} & ( 39 ) \\ {s}_{3} = {s}_{3 , R - 1} = {\tilde{N}}^{2} ( {\sum }_{r ∈ {P}^{+}} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{j 2 π Δ f \cdot 6 {τ}_{{u}_{0}}} {e}^{- j Δ θ} + {E}_{3} & ( 40 ) \\ {s}_{4} = {s}_{4 , R - 1} = {\tilde{N}}^{2} ( {\sum }_{r ∈ {P}^{+}} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{j 2 π Δ f \cdot 6 {τ}_{{u}_{0}}} {e}^{- j 3 Δ θ} + {E}_{4} & ( 41 ) \\ {s}_{5} = {s}_{5 , R - 1} = {\tilde{N}}^{2} ( {\sum }_{r ∈ {P}^{-}} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{- j 2 π Δ f \cdot 6 {τ}_{{u}_{0}}} {e}^{- j Δ θ} + {E}_{5} & ( 42 ) \\ {s}_{6} = {s}_{6 , R - 1} = {\tilde{N}}^{2} ( {\sum }_{r ∈ {P}^{-}} {\vert {H}_{{u}_{0} , r}^{( 1 )} \vert}^{2} + {\vert {H}_{{u}_{0} , r}^{( 2 )} \vert}^{2} ) {\vert {B}_{{u}_{0} , r}^{( i )} \vert}^{2} {e}^{- j 2 π Δ f \cdot 6 {τ}_{{u}_{0}}} {e}^{- j 3 Δ θ} + {E}_{6} & ( 43 )\end{matrix}$$

where:
P⁺ denotes the set of repetitions with a positive frequency hop 330;
P⁻ denotes the complementary set; and
Eᵢ denotes error from the ideal value due to noise.

As discussed above, the Δθ term of Eq. 38-39 interferes with the RTD estimation and therefore may be cancelled prior to proceeding with the RTD estimation. In aspects of the following, CFO cancellation may include a fine and/or coarse stage.

In a fine estimation stage, the CFO-related term AO may be estimated from Eq. 38-39 by calculating the differential of these two equations. That is:

Δ\hat{θ}≈½∠s₂s*₁ (44)

In some cases, the above equation may be augmented by similar (e.g., analogous) expressions involving Eq. 40-43. However, since the results of the additional expressions may be highly correlated with the original expression, doing so may provide a limited improvement on estimation accuracy. Further, Eq. 38-39 benefit from the maximal combining processing gain, which may contribute to mitigating the multiplicative noise associated with the differential operation.

Based at least in part on the definition of Δθ in Eq. 32, the estimation in Eq. 44 may be non-ambiguous only for frequency offsets which satisfy:

$$\vert {f}_{{u}_{0}} \vert < \frac{Δ f}{4 ( ɛ + {N}_{s} )} \qquad ( 45 )$$

where the upper bound corresponds to 178.57 Hz and 156.25 Hz for Format 0 and Format 1, respectively. In some examples, these upper bounds are lower than the target frequency offset of at least 250 Hz. Thus, Eq. 44 alone may, in some examples, be insufficient for CFO estimation. Accordingly, in some cases, a coarse estimation stage may be used to extend the range of estimation.

The following equation may be defined for the coarse estimation stage:

v_{i,g,r}=(Z_{0,g,r}⁽ⁱ⁾[l_{g,r}]+Z_{1,g,r}⁽ⁱ⁾[l_{g,r}])*(Z_{3,g,r}⁽ⁱ⁾[l_{g,r}]+Z_{4,g,r}⁽ⁱ⁾[l_{g,r}]) (46)

From the definition of Z_{m,g,r}⁽ⁱ⁾ in Eq. 13:

$${v}_{i , g , r} = {\vert {H}_{{u}_{0} , r}^{( i )} {B}_{{u}_{0} , r}^{( i )} {e}^{- j \frac{2 π}{N} {l}_{g , r} {τ}_{{u}_{0}} {F}_{s}} {\sum }_{n = 0}^{N - 1} {e}^{j2 π \frac{{f}_{{u}_{0}}}{{F}_{s}} n} \vert}^{2} {\vert 1 + {e}^{j 2 π {f}_{{u}_{0}} T} \vert}^{2} {e}^{j 2 π {f}_{{u}_{0}} 3 T} + {E}_{v} \qquad ( 47 )$$

where Eᵥ denotes deviation from the noise-free value.

Based on the result of Eq. 47, an estimate of the frequency offset with a wider estimation range than Eq. 44 may be obtained by defining the following estimator:

$$Δ {θ}_{c} = ∠ ( {\sum }_{r = 0}^{R - 1} {\sum }_{i = 1}^{2} {\sum }_{g = 0}^{3} {v}_{i , g , r} ) \qquad ( 48 )$$

where combining is performed across the time and space domain prior to phase extraction for maximal processing gain.

For the estimator in Eq. 48 the maximal frequency offset that can be estimated is bounded by:

$$\vert {f}_{{u}_{0}} \vert < \frac{Δ f}{6} \qquad ( 49 )$$

or approximately 625 Hz, which is sufficiently larger than the maximal permissible offset on the UE side. Thus, Eq. 49 does not suffer from the limitation of Eq. 44. However, due to the multiplications involved in Eq. 49, which are carried out at a lower processing gain compared to Eq. 44, the estimation accuracy of Eq. 44 is higher. Thus, in some cases, Eq. 48 may be used for disambiguation rather than for direct estimation.

Based on Eq. 44, the following relationship may be defined:

Δθ_{f}=∠s₂s*₁ (50)

Since the maximal permissible CFO on the UE side may be limited to approximately 230 Hz, in some cases it may suffice to resolve the ambiguity of the offset estimation to yield up to twice the maximal range of Eq. 45. Using Eq. 48 may resolve the ambiguity in Eq. 50 in the following manner:

$$Δ \hat{θ} = \{ \begin{matrix}\frac{Δ {θ}_{f}}{2} & Δ {θ}_{c} \geq \frac{6 ( {〈 Δ {θ}_{f} 〉}_{2 π} - π )}{4 ( ɛ + N )} \\ \frac{Δ {θ}_{f}}{2} - π & Δ {θ}_{c} < \frac{6 ( {〈 Δ {θ}_{f} 〉}_{2 π} - π )}{4 ( ɛ + N )}\end{matrix} \qquad ( 51 )$$

Theoretically, Eq. 51 enables CFO estimation up to 357.1 Hz and 312.5 Hz for Format 0 and Format 1, respectively. Practically, some margin may be required on account of noise-induced wrap-around (e.g., such that the practical maximal supported CFO may be approximately 300 Hz for Format 0 and 280 Hz for Format 1, respectively.

Using the CFO estimate, CFO correction may be applied to Eq. 38-43. Accordingly, accumulators may be combined in the following manner:

D₁=s₁e^{jΔ\tilde{θ}}+s₂e^{-jΔ\tilde{θ}} (52)

D₂=s₃e^{jΔ\tilde{θ}}+s₄e^{j3Δ\tilde{θ}}+s*₅e^{-jΔ\tilde{θ}}+s*₆e^{-j3Δ\tilde{θ}} (53)

These equations may be approximated as:

$$\begin{matrix}{D}_{1} \approx {Ae}^{j 2 πΔ f \cdot {τ}_{{u}_{0}}} & ( 54 ) \\ {D}_{2} \approx {Ae}^{j 2 πΔ f \cdot 6 {τ}_{{u}_{0}}} & ( 55 )\end{matrix}$$

where A is a real positive number.

D₂ carries the dominant part of the phase information, whereas D₁ may provide useful information for phase disambiguation. Therefore, the RTD may be estimated in the following manner:

$$\begin{matrix}{\hat{ϕ}}_{1} = {〈 ∠ {D}_{1} 〉}_{2 π} & ( 56 ) \\ {\hat{ϕ}}_{6} = \frac{1}{6} {〈 ∠ {D}_{6} 〉}_{2 π} & ( 57 ) \\ \hat{τ} = \frac{1}{2 π Δ f} ( {\hat{ϕ}}_{6} + \frac{2 π}{6} ⌊ \frac{{〈 {\hat{ϕ}}_{1} - ( {\hat{ϕ}}_{6} - \frac{2 π}{12} ) 〉}_{2 π}}{\frac{2 π}{6}} ⌋ ) & ( 58 )\end{matrix}$$

Eq. 57 may be associated with some measure of inherent ambiguity, while Eq. 56 may be non-ambiguous.

The signals of nearby UEs 115 (i.e., UEs 115 near to a base station 105) may be prone to relatively large errors (e.g., since the noise may drive the received signal to negative angels, which may typically be associated with UEs 115 at the cell edge). To avoid such errors, a noise margin may be specified such that signals within the noise margin region will be associated with nearby UEs 115 rather than with cell-edge ones. Such a noise margin may slightly reduce the maximal supported cell radius.

The required magnitude of the noise margin may be derived from the expected RTD estimation accuracy. For example, given an upper bound on the maximal RTD estimation error, the noise margin (in radian units) may be derived as follows:

ΔΘ=2πf6E_{θ,max}[rad] (59)

where E_{θ,max} is an upper bound on the permissible absolute RTD estimation error. As a result, the maximal range may be reduced by:

$$Δ R = \frac{2 Δ Θ \cdot 3 \cdot {10}^{8}}{4 π Δ f 6} = {E}_{θ , max} \cdot 3 \cdot {10}^{8} [ m ] \qquad ( 60 )$$

where ΔR is calculated based on twice the noise-margin (e.g., to avoid false identifications of cell-edge UEs 115 as nearby UEs 115). For example, taking E_{θ,max}=3.646 μs results in roughly 1 km range shortening.

In some cases, a narrowband receiver as described herein may additionally or alternatively perform signal detection. Some quantities already computed during the estimation stage may be reused for detection (e.g., to reduce the computational load on the receiver without significantly impacting performance). For example, detection may be performed in the following manner:

$$\frac{1}{{\hat{σ}}^{4}} ( {\vert {D}_{1} \vert}^{2} + {\vert {D}_{6} \vert}^{2} ) > λ \qquad ( 61 )$$

where D₁, D₆ are defined in Eq. 54-55 and where \hat{σ}² is an estimate of the noise power, given by:

$${\hat{σ}}^{2} = {\sum }_{r = 0}^{R - 1} {\sum }_{g = 0}^{{N}_{g}} {\sum }_{m = 1}^{{N}_{s}} {\sum }_{i = 1}^{2} {\sum }_{u = 1}^{U} \vert {Z}_{m , g , r}^{( i )} [ k ( u , g , r ) ] - {{Z}_{m - 1 , g , r}^{( i )} [ k ( u , g , r ) ]}^{2} \qquad ( 62 )$$

where Z_{m,g,r}⁽ⁱ⁾[l] is defined in Eq. 12. As conveyed in Eq. 62, noise estimation may in some cases be based on the data of all NPRACH subcarriers (e.g., across narrowband portion 320) in order to improve statistical validity.

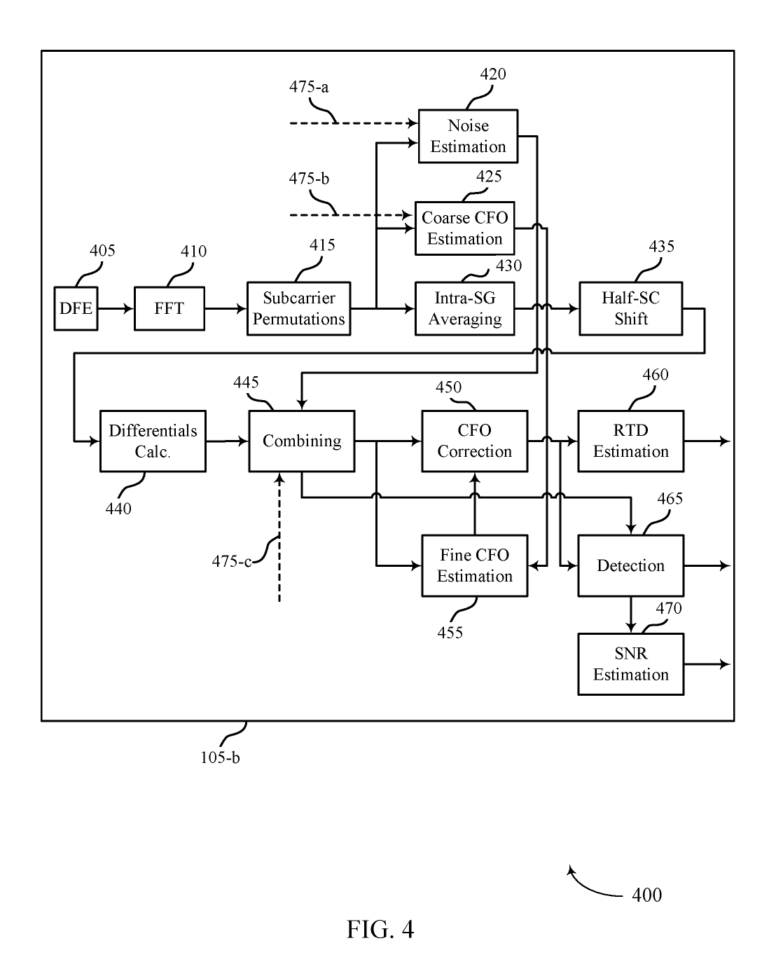

FIG. 4 illustrates an example of a receiver diagram 400 that supports narrowband random access for wireless communications in accordance with various aspects of the present disclosure. In some examples, receiver diagram 400 may implement aspects of wireless communications systems 100 or 200 as described with reference to FIGS. 1 and 2. Receiver diagram 400 may be an example of or a component of a base station 105-b, which may in turn be an example of the corresponding device described above. In some cases, receiver diagram 400 may be an example of or a component of a UE 115 as described above (e.g., in a D2D communication scheme). In aspects of the following, a dotted arrow (e.g., as input to noise estimation at 420, coarse CFO estimation at 425, and combining at 445) may indicate information 475 from a second antenna (e.g., which may improve the statistical validity of the results). In some cases, the described techniques may be applied to information received over more than two antennas (e.g., which may further improve the statistical validity of the results).

Aspects of the following are described in the context of an example implementation of the concepts developed above using a digital signal processor (DSP). This example is included for the sake of explanation and is not limiting of scope. Accordingly, various aspects of the following description constitute a re-formulation of the above-described equations in a manner that is more suitable for DSP implementation. However, it is to be understood that the described concepts may instead be re-formulated and performed using similar DSP functionality and/or analogous signal processing techniques without deviating from the scope of the present disclosure.

The following notations are employed in the equations that follow:
Signal indices: 0≤m≤4 denotes the symbol index within a symbol group; 0≤g≤3 denotes the symbol group index; 0≤r≤R−1 denotes the repetition index.
[v]ₖ denotes the k^{th} element of the vector v.
[symbol] denotes quantization of the enclosed argument into p bits, where the LSB is located at bit index q, counting from the first bit to the right of the radix point.
Quantization is performed to a signed value. [symbol] denotes quantization to an unsigned value.
rnd(□) denotes symmetric rounding, where mid-levels are alternately mapped to even and odd values.
sat(□) denotes (non-symmetric) saturation.
drp_msb(□) denotes dropping of one or more most significant bits (MSBs).
sign_ext(□) denotes sign extension.
zero_pad(□) denotes zero-padding of MSBs.
∠(□) denotes the angle of the enclosed expression, where the result is assumed to be normalized by, and lie in the range [−1,1) (i.e., greater than or equal to −1 and less than 1).
take_msb(□) denotes extraction of one or more MSBs.

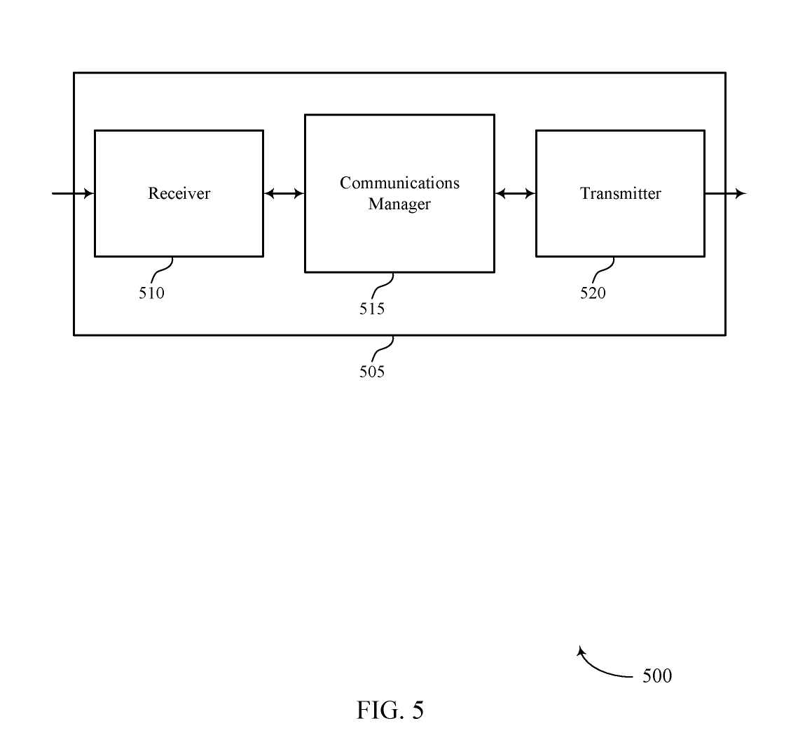

Various techniques described with reference to receiver diagram 400 may be implemented by special purpose hardware, software executed by a processor, firmware, or any combination thereof. For instance, the techniques or operations as described with reference to receiver diagram 400 may be implemented by various components of a wireless device, such as a base station 105 or a UE 115, as described herein. Examples of components that may be used include those described with reference to FIGS. 5 through 8. However, additional or different components may be used to perform the operations described herein without departing from the scope of the present disclosure.

At 405, digital front end (DFE) processing may be performed. Because of the 3.75 kHz subcarrier spacing of NPRACH (i.e., frequency hop 325 as described with reference to FIG. 3), DFE processing of the NPRACH signal may be performed in a separate DFE chain from other physical channels (e.g., which may use a different subcarrier spacing). At block 405, one or both of the following operations may be performed:
Down-sampling from the Primary Rate Interface (PRI) rate (e.g., 345.6/2=172.8 MHz) to the Fast Fourier Transform (FFT) input sampling rate (e.g., F_{S}=240 kHz), where the FFT initial placement is set to the beginning of the first symbol in the each symbol group (i.e., right after the CP).
Half SC shift removal (e.g., by setting the numerically controlled oscillator (NCO) frequency to

$${ω}_{0} = - 2 π \frac{1}{2} \frac{Δ f}{{F}_{s , NCO}} [ \frac{rad}{samp} ] ,$$

where F_{s,NCO} denotes the NCO sampling rate).

At 410, an FFT may be performed to transform the time domain signal at the DFE output to the frequency domain. The FFT may be performed in hardware, software, or a combination thereof. The operation performed at 410 may be approximated by the following:

$${\tilde{Z}}_{m , g , r}^{( i )} [ l ] \approx {rnd ( {rnd ( {\sum }_{n = 0}^{N - 1} {z}_{m , g , r}^{( i )} [ n ] {e}^{- j \frac{2 π}{N} ln} )}_{〈 22 , 15 〉} )}_{〈 16 , 15 - S 〉} \qquad ( 63 )$$

where N=64 (or 2^{x} where x is a positive integer) is the FFT size and S∈[0, . . . , 6] is the value of the FFT right-shifter at the output of the FFT module. In some cases, the value may be determined so as not to incur degradation in sensitivity while broadening the dynamic range of the incoming signal as much as possible.

Due to the small bandwidth of the NPRACH signal and the relatively low SNRs at its sensitivity points, the automatic gain control (AGC) may settle on a maximal gain stage at all repetition levels. Since the lowest sensitivity point is approximately 13 dB, it follows that the subcarrier power (including noise) at the analog to digital converter (ADC) input may be approximated as:

P_{ADC}≈−174+10 log₁₀(Δf)+NF+G[dBm] (64)

where NF stands for the noise-figure and G denotes the AGC gain.

Considering that the ADC full-scale is attained at 13.8 dBm, the power at the FFT input may be given by:

P_{FFT}_{_}_{IN}=P_{ADC}−13.8[dBFS] (65)

Thus, the subcarrier power may be given by:

$${P}_{SC} = {P}_{FFT \_ IN} - 10 {log}_{10} ( {( \frac{Δ f}{{F}_{s}} )}^{2} ) = - 174 + NF + G - 1308 - 10 {log}_{10} ( \frac{Δ f}{{F}_{s}^{2}} ) \qquad ( 66 )$$

In order for quantization at the FFT output to be negligible, the signal (e.g., the thermal noise) to quantization noise ratio be greater than 15 dB, giving rise to the following equation:

1.77+6·16+P_{SC}−6S>15 (67)

Solving for S yields the requirement:

$$S < \frac{- 105 + NF + G - 10 {log}_{10} ( \frac{Δ f}{{F}_{s}^{2}} )}{6} \qquad ( 68 )$$

Substituting the typical values NF=3 dB, G 50 dB, Fₛ=240 kHz yields:

S<3.31 (69)

Thus, for a stand-alone mode S=3 may be the proper value, which leads to the following FFT block equation:

$${\tilde{Z}}_{m , g , r}^{( i )} [ l ] \approx {rnd ( {rnd ( {\sum }_{n = 0}^{N - 1} {z}_{m , g , r}^{( i )} [ n ] {e}^{- j \frac{2 π}{N} ln} )}_{〈 22 , 15 〉} )}_{〈 16 , 12 〉}$$

Right-shifting by 3, yields the FFT output:

Z_{m,g,r}⁽ⁱ⁾[l]=(\tilde{Z}_{m,g,r}⁽ⁱ⁾[l]>>3) [symbol] _{16,15} [symbol] (70)

which may serve as input to subcarrier permutations performed at 415.

At 415, subcarrier permutation may be performed (e.g., to simplify subsequent calculations) based on the hopping sequence in order for incoming samples from each UE 115 to be contiguous.

Defining:

z_{m,g,r}⁽ⁱ⁾=[Z_{m,g,r}⁽ⁱ⁾[l₀] Z_{m,g,r}⁽ⁱ⁾[l₀+1] . . . Z_{m,g,r}⁽ⁱ⁾[l₀+11]]^{T} (71)

where l₀ denotes sub-carrier index of the first NPRACH sub-carrier within the current NPRACH resource. In aspects, the term “resource” refers to a set of 12 subcarriers (i.e., frequency portion 320 as described with reference to FIG. 3) in which a NPRACH transmission may occur. In some cases, there may be up to four (4) such resources within a NB-IoT resource block.

Letting 0≤k_{SC}(i,n)≤11 denote the NPRACH subcarrier index at symbol-group index 0≤n≤4R−1, which is associated with the transmission initiated at sub-carrier index 0≤i≤11, the permuted vector may be related to the input vector by the following relation:

$${[ {\tilde{z}}_{m , g , r}^{( i )} ]}_{k} = {[ {z}_{m , g , r}^{( i )} ]}_{{k}_{SC} ( k , 4 r + g )} \qquad ( 72 )$$

The sequence k_{SC} (i,n) may known a-priori and in some cases may be directly constructed from the hopping sequence. \hat{z}_{m,g,r}⁽ⁱ⁾ may be the output of the subcarrier permutations at 415.

At 425, a coarse CFO estimate may be obtained through the following processing:

$$\begin{matrix}{[ \tilde{v} ]}_{k} = {( {\sum }_{r = 0}^{R - 1} rnd \& {sat ( {( {\sum }_{i = 1}^{2} {( {\sum }_{g = 0}^{3} {( {( {( {[ {\tilde{z}}_{0 , g , r}^{( i )} ]}_{k} + {[ {\tilde{z}}_{1 , g , r}^{( i )} ]}_{k} )}_{〈 17 , 15 〉} )}^{*} ( {( {[ {\tilde{z}}_{3 , g , r}^{( i )} ]}_{k} + {[ {\tilde{z}}_{4 , g , r}^{( i )} ]}_{k} )}_{〈 17 , 15 〉} ) )}_{〈 34 , 30 〉} )}_{〈 36 , 30 〉} )}_{〈 37 , 30 〉} )}_{〈 33 , 27 〉} )}_{〈 40 , 27 〉} & ( 74 ) \\ {[ {e}_{c} ]}_{k} = clb ( {[ \tilde{v} ]}_{k} ) & ( 75 ) \\ {[ v ]}_{k} = {extract ( {[ \tilde{v} ]}_{k} , {[ {e}_{c} ]}_{k} )}_{〈 16 , 15 〉} & ( 76 )\end{matrix}$$

In some cases, a complementary coarse CFO estimate may be obtained through analogous processing of information 475-b from a second antenna. The coarse CFO estimates may be combined (e.g., in order to improve the statistical validity of the results).

At 420, noise estimation may be performed in the following manner:

$${\hat{σ}}_{w}^{2} = {( {\sum }_{r = 0}^{R - 1} {\sum }_{g = 0}^{3} {\sum }_{m = 1}^{4} {\sum }_{i = 1}^{2} {\sum }_{k = 1}^{12} {sat ( {( {\vert {( {[ {\tilde{z}}_{m , g , r}^{( i )} ]}_{k} - {[ {\tilde{z}}_{m - 1 , g , r}^{( i )} ]}_{k} )}_{〈 17 , 15 〉} \vert}^{2} )}_{〈 34 , 30 〉} >> 6 )}_{〈 24 , 36 〉} )}_{〈 40 , 36 〉} \qquad ( 77 )$$

In some cases, the noise estimate may be supplemented through analogous processing of information 475-b received from a second antenna (e.g., which may improve the statistical validity of the results).

At 430, intra symbol group (SG) may be performed (e.g., to improve SNR). In some cases intra-SG averaging on the k^{th} subcarrier index may be performed by the following equation:

$${[ {m}_{g , r}^{( i )} ]}_{k} = rnd \& {sat ( {( {\sum }_{m = 0}^{4} {[ {\tilde{z}}_{m , g , r}^{( i )} ]}_{k} )}_{〈 19 , 15 〉} )}_{〈 16 , 15 〉} \qquad ( 78 )$$

At 435, a half SC shift correction may be given by the following relation:

$$\begin{matrix}{[ {\tilde{m}}_{g , r}^{( i )} ]}_{k} = rnd \& {sat ( {( {[ {m}_{g , r}^{( i )} ]}_{k} \cdot {( {e}^{j {πφ}_{4 r + g}} )}_{〈 16 , 15 〉} )}_{〈 32 , 30 〉} )}_{〈 16 , 15 〉} & ( 79 ) \\ {φ}_{n} = drp\_msb {( {( {( {φ}_{n - 1} )}_{〈 16 , 15 〉} + {( Δ φ )}_{〈 8 , 2 〉} )}_{〈 22 , 15 〉} )}_{〈 16 , 15 〉} & ( 80 ) \\ {φ}_{0} = 0 & ( 81 ) \\ Δφ = \{ \begin{matrix}5.25 & Format 0 \\ 6 & Format 1\end{matrix} & ( 82 )\end{matrix}$$

At 440, the symbol group differentials may be calculated in the following manner:

$$\begin{matrix}{[ {D}_{01 , r}^{( i )} ]}_{k} = {( {{[ {m}_{0 , r}^{( i )} ]}_{k} [ {m}_{1 , r}^{( i )} ]}_{k}^{*} )}_{〈 32 , 30 〉} & ( 83 ) \\ {[ {D}_{32 , r}^{( i )} ]}_{k} = {( {{[ {m}_{3 , r}^{( i )} ]}_{k} [ {m}_{2 , r}^{( i )} ]}_{k}^{*} )}_{〈 32 , 30 〉} & ( 84 ) \\ {[ {D}_{12 , r}^{( i )} ]}_{k} = {( {{[ {m}_{1 , r}^{( i )} ]}_{k} [ {m}_{2 , r}^{( i )} ]}_{k}^{*} )}_{〈 32 , 30 〉} & ( 85 ) \\ {[ {D}_{03 , r}^{( i )} ]}_{k} = {( {{[ {m}_{0 , r}^{( i )} ]}_{k} [ {m}_{3 , r}^{( i )} ]}_{k}^{*} )}_{〈 32 , 30 〉} & ( 86 )\end{matrix}$$

At 445, combining may be performed based on maintaining six (6) accumulators per NPRACH subcarrier, wherein each accumulator is updated based at least in part on the hopping sequence (i.e., each differential operation is mapped to a respective subcarrier based at least in part on the hopping sequence). Aspects of the following are described in the context of processing performed for a single antenna. However, in some cases, the combining at 445 may include additional information 475-c from a second antenna (e.g., in order to improve the statistical validity of the results).

The update term of the first two (vector) accumulators depends on the index of the first symbol group within each repetition in the following manner:

$$\begin{matrix}{( {[ {s}_{1 , r} ]}_{k} )}_{〈 40 , 30 〉} = {( {[ {s}_{1 , r - 1} ]}_{k} )}_{〈 40 , 30 〉} + \{ \begin{matrix}{( {[ {D}_{01 , r}^{( 1 )} ]}_{k} + {[ {D}_{01 , r}^{( 2 )} ]}_{k} )}_{〈 33 , 30 〉} & {k}_{SC} ( k , 4 r ) even \\ {( {[ {D}_{32 , r}^{( 1 )} ]}_{k}^{*} + {[ {D}_{32 , r}^{( 2 )} ]}_{k}^{*} )}_{〈 33 , 30 〉} & {k}_{SC} ( k , 4 r ) odd\end{matrix} & ( 87 ) \\ {( {[ {s}_{2 , r} ]}_{k} )}_{〈 40 , 30 〉} = {( {[ {s}_{2 , r - 1} ]}_{k} )}_{〈 40 , 30 〉} + \{ \begin{matrix}{( {[ {D}_{32 , r}^{( 1 )} ]}_{k} + {[ {D}_{32 , r}^{( 2 )} ]}_{k} )}_{〈 33 , 30 〉} & {k}_{SC} ( k , 4 r ) even \\ {( {[ {D}_{01 , r}^{( 1 )} ]}_{k}^{*} + {[ {D}_{01 , r}^{( 2 )} ]}_{k}^{*} )}_{〈 33 , 30 〉} & {k}_{SC} ( k , 4 r ) odd\end{matrix} & ( 88 )\end{matrix}$$

The update of the next two accumulators depends on the index of the second symbol group within each repetition:

$$\begin{matrix}\{ \begin{matrix}\begin{matrix}{( {[ {s}_{3 , r} ]}_{k} )}_{〈 40 , 30 〉} = {( {[ {s}_{3 , r - 1} ]}_{k} )}_{〈 40 , 30 〉} + \\ {( {[ {D}_{12 , r}^{( 1 )} ]}_{k} + {[ {D}_{12 , r}^{( 2 )} ]}_{k} )}_{〈 33 , 30 〉}\end{matrix} & {k}_{SC} ( k , 4 r + 1 ) < 6 \\ \begin{matrix}{( {[ {s}_{5 , r} ]}_{k} )}_{〈 40 , 30 〉} = {( {[ {s}_{5 , r - 1} ]}_{k} )}_{〈 40 , 30 〉} + \\ {( {[ {D}_{12 , r}^{( 1 )} ]}_{k} + {[ {D}_{12 , r}^{( 2 )} ]}_{k} )}_{〈 33 , 30 〉}\end{matrix} & {k}_{SC} ( k , 4 r + 1 ) \geq 6\end{matrix} & ( 89 ) \\ \{ \begin{matrix}\begin{matrix}{( {[ {s}_{4 , r} ]}_{k} )}_{〈 40 , 30 〉} = {( {[ {s}_{4 , r - 1} ]}_{k} )}_{〈 40 , 30 〉} + \\ {( {[ {D}_{03 , r}^{( 1 )} ]}_{k} + {[ {D}_{03 , r}^{( 2 )} ]}_{k} )}_{〈 33 , 30 〉}\end{matrix} & {k}_{SC} ( k , 4 r + 1 ) < 6 \\ \begin{matrix}{( {[ {s}_{6 , r} ]}_{k} )}_{〈 40 , 30 〉} = {( {[ {s}_{6 , r - 1} ]}_{k} )}_{〈 40 , 30 〉} + \\ {( {[ {D}_{03 , r}^{( 1 )} ]}_{k} + {[ {D}_{03 , r}^{( 2 )} ]}_{k} )}_{〈 33 , 30 〉}\end{matrix} & {k}_{SC} ( k , 4 r + 1 ) \geq 6\end{matrix} & ( 90 ) \\ where \text{:} & \\ {[ {s}_{q , - 1} ]}_{k} = 0 ∀ q & ( 91 )\end{matrix}$$

and k_{SC} (k,n) is defined as above (i.e., with reference to the subcarrier permutations at 415).

The combining results at the last repetition may be quantized and output for further processing as specified below:

$$\begin{matrix}{[ {e}_{1} ]}_{k} = clb ( {[ {s}_{1 , R - 1} ]}_{k} ) & ( 92 ) \\ {e}_{n} = clb ( {\hat{σ}}_{w}^{2} ) & ( 93 ) \\ {[ {e}_{s} ]}_{k} = min ( {[ {e}_{1} ]}_{k} - 2 , {e}_{n} ) & ( 94 ) \\ {[ {s}_{q} ]}_{k} = {extract ( {[ {s}_{q , R - 1} ]}_{k} , {[ {e}_{s} ]}_{k} )}_{〈 16 , 15 〉} ∀ q & ( 95 ) \\ {[ μ ]}_{k} = drp\_msb {( {extract ( {\hat{σ}}_{w}^{2} , {[ {e}_{s} ]}_{k} )}_{〈 16 , 15 〉} )}_{〈 15 , 15 〉 us} & ( 96 )\end{matrix}$$

where \hat{σ}_{w}² is determined in the noise estimation at 420.

At 455, the fine CFO estimation may be obtained by the following expressions:

$$\begin{matrix}{[ {Δθ}_{f} ]}_{k} = drp\_msb {( sign\_ext {( {( ∠ rnd \& {sat ( {( {[ {s}_{1} ]}_{k}^{*} )}_{〈 16 , 15 〉} {( {[ {s}_{2} ]}_{k} )}_{〈 16 , 15 〉} )}_{〈 16 , 15 〉} )}_{〈 16 , 15 〉} )}_{〈 17 , 15 〉} )}_{〈 16 , 15 〉 us} & ( 97 ) \\ {[ Δθ ]}_{k} = \{ \begin{matrix}{rnd ( zero\_pad {( {( \frac{{[ {Δθ}_{f} ]}_{k}}{2} )}_{〈 16 , 16 〉 us} )}_{〈 17 , 16 〉} )}_{〈 16 , 15 〉} & rnd \& {sat ( {( {( {[ {Δθ}_{c} ]}_{k} )}_{〈 16 , 15 〉} \cdot {( {c}_{θ} )}_{〈 8 , 1 〉} )}_{〈 24 , 16 〉} )}_{〈 16 , 13 〉} \geq {( {[ {Δθ}_{f} ]}_{k} - 1 )}_{〈 16 , 15 〉} \\ {rnd ( {( \frac{{[ {Δθ}_{f} ]}_{k}}{2} - 1 )}_{〈 17 , 16 〉} )}_{〈 16 , 15 〉} & rnd \& {sat ( {( {( {[ {Δθ}_{c} ]}_{k} )}_{〈 16 , 15 〉} \cdot {( {c}_{θ} )}_{〈 8 , 1 〉} )}_{〈 24 , 16 〉} )}_{〈 16 , 13 〉} < {( {[ {Δθ}_{f} ]}_{k} - 1 )}_{〈 16 , 15 〉}\end{matrix} & ( 98 ) \\ {c}_{θ} = \{ \begin{matrix}{( 3.5 )}_{〈 8 , 1 〉} & Format 0 \\ {( 4 )}_{〈 8 , 1 〉} & Format 1\end{matrix} & ( 99 )\end{matrix}$$

where Δθ_{c} is determined in the coarse CFO estimate at 425.

At 450, CFO correction may be performed in the following manner:

$$\begin{matrix}{[ {D}_{1} ]}_{k} = rnd \& {sat ( {( {( {( {[ {s}_{1} ]}_{k} )}_{〈 16 , 15 〉} {( {e}^{j {π [ Δθ ]}_{k}} )}_{〈 16 , 15 〉} )}_{〈 32 , 30 〉} + {( {( {[ {s}_{2} ]}_{k} )}_{〈 16 , 15 〉} {( {e}^{- j {π [ Δθ ]}_{k}} )}_{〈 16 , 15 〉} )}_{〈 32 , 30 〉} )}_{〈 33 , 30 〉} )}_{〈 16 , 16 〉} & ( 100 ) \\ {[ {D}_{2} ]}_{k} = rnd \& {sat ( {( \begin{matrix}{[ {s}_{3} ]}_{k} {( {e}^{j {π [ Δθ ]}_{k}} )}_{〈 16 , 15 〉} + {[ {s}_{4} ]}_{k} {( {e}^{j π drp \_ {msb ( {( {3 [ Δθ ]}_{k} )}_{〈 18 , 15 〉} )}_{〈 16 , 15 〉}} )}_{〈 16 , 15 〉} + \\ {[ {s}_{5} ]}_{k}^{*} {( {e}^{- j {π [ Δθ ]}_{k}} )}_{〈 16 , 15 〉} + {[ {s}_{6} ]}_{k}^{*} {( {e}^{- j π drp \_ {msb ( {( {3 [ Δθ ]}_{k} )}_{〈 18 , 15 〉} )}_{〈 16 , 15 〉}} )}_{〈 16 , 15 〉}\end{matrix} )}_{〈 34 , 30 〉} )}_{〈 16 , 16 〉} & ( 101 )\end{matrix}$$

At 460, the RTD estimation process may involve the following calculations:

$$\begin{matrix}{[ {ϕ}_{1} ]}_{k} = drp\_msb {( sign\_ext ( {( {∠ [ {D}_{1} ]}_{k} )}_{〈 16 , 15 〉} ) )}_{〈 16 , 15 〉 us} & ( 102 ) \\ {[ {\tilde{ϕ}}_{6} ]}_{k} = drp\_msb {( sign\_ext ( {( {∠ [ {D}_{2} ]}_{k} )}_{〈 16 , 15 〉} ) )}_{〈 16 , 15 〉 us} & ( 103 )\end{matrix}$$

In some cases, a noise margin may be applied as described above using the following:

$${[ {ϕ}_{6} ]}_{k} = \{ \begin{matrix}{[ {\tilde{ϕ}}_{6} ]}_{k} & {[ {\tilde{ϕ}}_{6} ]}_{k} \leq {( 2 - {( noise\_margin )}_{〈 15 , 15 〉 us} )}_{〈 16 , 15 〉 us} \\ 0 & o . w .\end{matrix} \qquad ( 104 )$$

where the parameter noise_margin may be configurable with a default value. For example:

noise_margin(default)=0×1500 (105)

The RTD estimate of the k^{th} opportunity [\hat{τ}]ₖ, given in μs, is given by:

$$\begin{matrix}{[ \hat{τ} ]}_{k} = {rnd ( {( {c}_{τ} )}_{〈 16 , 11 〉 us} {( {( {[ {ϕ}_{6} ]}_{k} )}_{〈 16 , 15 〉 us} + {( 2 \cdot take\_msb {( 𝒳 )}_{〈 3 , 0 〉 us} )}_{〈 3 , 1 〉 us} )}_{〈 19 , 15 〉 us} )}_{〈 16 , 7 〉 us} & ( 106 ) \\ 𝒳 = {( 3 \cdot drp\_msb {( {( {( {[ {ϕ}_{1} ]}_{k} )}_{〈 16 , 15 〉 us} - rnd \& {sat ( {( {( \frac{1}{6} )}_{〈 16 , 17 〉} {( {[ {ϕ}_{6} ]}_{k} - 1 )}_{〈 16 , 15 〉} )}_{〈 32 , 32 〉} )}_{〈 16 , 17 〉} )}_{〈 20 , 17 〉} )}_{〈 18 , 17 〉 us} )}_{〈 20 , 17 〉 us} & ( 107 ) \\ where & \\ {c}_{τ} = 0 xB 1 C 7 & ( 108 )\end{matrix}$$

At 465, access message detection may be determined according to:

$$\begin{matrix}{\hat{D}}_{2} = drp\_msb {( {( {\vert {[ {D}_{2} ]}_{k} \vert}^{2} )}_{〈 32 , 32 〉} )}_{〈 31 , 32 〉 us} & ( 109 ) \\ {[ T ]}_{k} = {( drp\_msb {( {( {\vert {[ {D}_{2} ]}_{k} \vert}^{2} )}_{〈 32 , 32 〉} )}_{〈 31 , 32 〉 us} + {\hat{D}}_{2} )}_{〈 32 , 32 〉 us} & ( 110 ) \\ detector\_out = \{ \begin{matrix}DTX & {[ T ]}_{k} < {[ {λ}_{R} ]}_{k} \\ signal\_detected & {[ T ]}_{k} \geq {[ {λ}_{R} ]}_{k}\end{matrix} & ( 111 ) \\ where \text{:} & \\ {[ {λ}_{R} ]}_{k} = {( {( {\tilde{λ}}_{R} )}_{〈 16 , 12 〉 us} {( {[ {μ}_{s} ]}_{k} )}_{〈 16 , 16 〉 us} )}_{〈 32 , 28 〉 us} & ( 112 ) \\ {[ {μ}_{s} ]}_{k} = {rnd ( {( {[ μ ]}_{k}^{2} )}_{〈 30 , 30 〉 us} )}_{〈 16 , 16 〉 us} & ( 113 )\end{matrix}$$

and where μ is defined in Eq. 96 and \tilde{λ}_{R} is a repetition-dependent threshold that is read from a look-up table. In some cases, the detector's false-alarm rate may be calibrated to a certain value (e.g., 10⁻).

At 470, the post-processing SNR in units of dB may be estimated in the following manner:

$${[ SNR ]}_{k} = {sat ( \begin{matrix}{( 10 {log}_{10} ( rnd \& {sat ( {[ {\hat{D}}_{2} ]}_{k} )}_{〈 15 , 15 〉 us} ) )}_{〈 16 , 9 〉} - \\ {( 10 {log}_{10} ( {[ {μ}_{s} ]}_{k} ) )}_{〈 16 , 9 〉} + {( - 6.37 )}_{〈 16 , 9 〉}\end{matrix} )}_{〈 16 , 9 〉} \qquad ( 114 )$$

where \hat{D}₂ and μₛ were defined in Eq. 109 and 113, respectively, and a normalization factor

$$( i . e . , 10 {log}_{10} ( {( \frac{{2}^{2} \cdot 64 \cdot 12 \cdot R}{{5}^{2} \cdot 2 R \cdot 2 \cdot {2}^{6}} )}^{2} ) \approx - 6.37 )$$

is introduced.

FIG. 5 shows a diagram 500 of a wireless device 505 that supports narrowband random access for wireless communications in accordance with aspects of the present disclosure. Wireless device 505 may be an example of aspects of a base station 105 as described herein. Wireless device 505 may include receiver 510, communications manager 515, and transmitter 520. Wireless device 505 may also include a processor. Each of these components may be in communication with one another (e.g., via one or more buses).

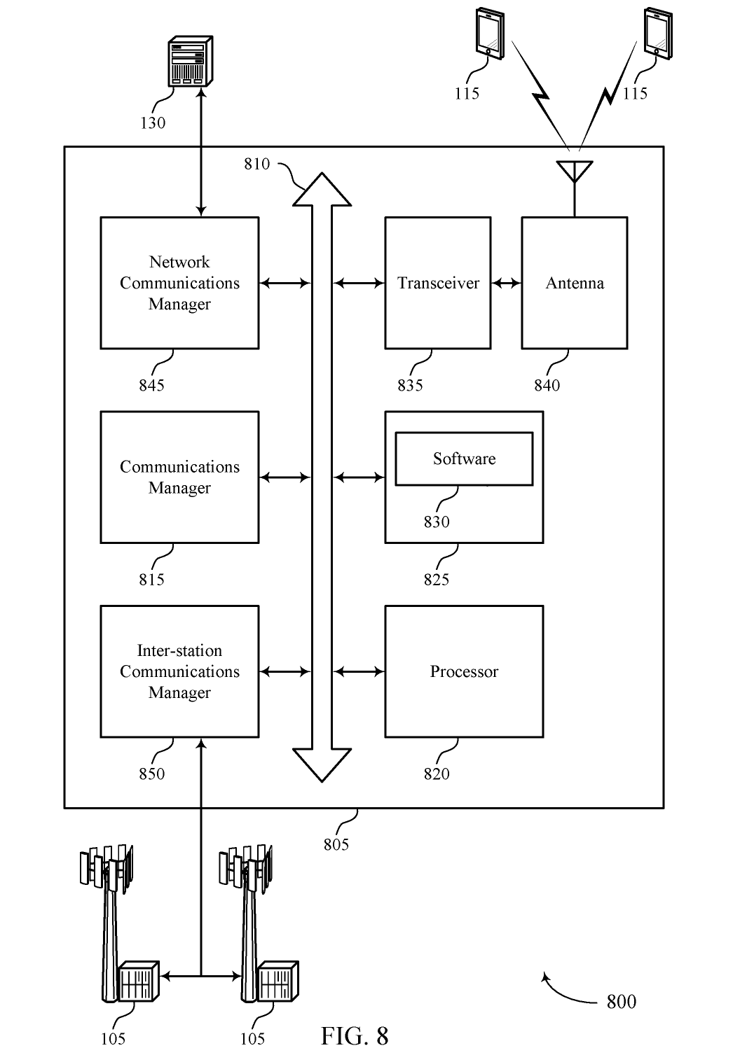

Receiver 510 may receive information such as packets, user data, or control information associated with various information channels (e.g., control channels, data channels, and information related to narrowband random access for wireless communications, etc.). Information may be passed on to other components of the device. The receiver 510 may be an example of aspects of the transceiver 835 described with reference to FIG. 8. The receiver 510 may utilize a single antenna or a set of antennas.

Communications manager 515 may be an example of aspects of the communications manager 815 described with reference to FIG. 8.

Communications manager 515 and/or at least some of its various sub-components may be implemented in hardware, software executed by a processor, firmware, or any combination thereof. If implemented in software executed by a processor, the functions of the communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 515 and/or at least some of its various sub-components may be physically located at various positions, including being distributed such that portions of functions are implemented at different physical locations by one or more physical devices. In some examples, communications manager 515 and/or at least some of its various sub-components may be a separate and distinct component in accordance with various aspects of the present disclosure. In other examples, communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 515 may receive, at a base station from a UE, an access request including an identification of a set of sets of symbol groups and perform a set of differential operations for each set of symbol groups. Communications manager 515 may map each differential operation to a corresponding accumulator of a set of accumulators and estimate an RTD time between the UE and the base station based on the mapped differential operations.

Transmitter 520 may transmit signals generated by other components of the device. In some examples, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

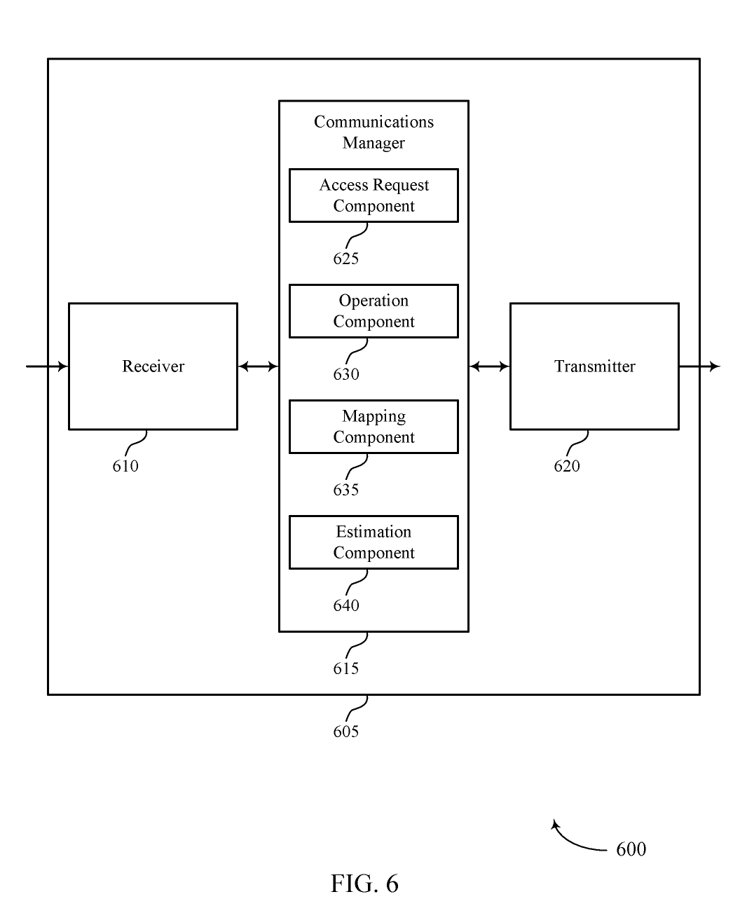

FIG. 6 shows a diagram 600 of a wireless device 605 that supports narrowband random access for wireless communications in accordance with aspects of the present disclosure. Wireless device 605 may be an example of aspects of a wireless device 505 or a base station 105 as described with reference to FIG. 5. Wireless device 605 may include receiver 610, communications manager 615, and transmitter 620. Wireless device 605 may also include a processor. Each of these components may be in communication with one another (e.g., via one or more buses).

Receiver 610 may receive information such as packets, user data, or control information associated with various information channels (e.g., control channels, data channels, and information related to narrowband random access for wireless communications, etc.). Information may be passed on to other components of the device. The receiver 610 may be an example of aspects of the transceiver 835 described with reference to FIG. 8. The receiver 610 may utilize a single antenna or a set of antennas.

Communications manager 615 may be an example of aspects of the communications manager 815 described with reference to FIG. 8. Communications manager 615 may also include access request component 625, operation component 630, mapping component 635, and estimation component 640.

Access request component 625 may receive, at a base station from a UE, an access request including an identification of a set of sets of symbol groups. In some cases, the identification of the set of sets of symbol groups includes a first format of the access request, the first format having a first CP length, or a second format of the access request, the second format having a second CP length longer than the first CP length.

Operation component 630 may perform a set of differential operations for each set of symbol groups.

Mapping component 635 may map each differential operation to a corresponding accumulator of a set of accumulators.

Estimation component 640 may estimate an RTD time between the UE and the base station based on the mapped differential operations and divide the set of accumulators into a first group of accumulators and a second group of accumulators, where the first group of accumulators conveys a dominant portion of phase information associated with the access request and the second group of accumulators conveys phase disambiguation information. Estimation component 640 may calculate the RTD time based on the first group of accumulators and the second group of accumulators. In some cases, estimating the RTD time includes: frequency correcting each of the set of accumulators based on the estimated CFO term.

Transmitter 620 may transmit signals generated by other components of the device. In some examples, the transmitter 620 may be collocated with a receiver 610 in a transceiver module. For example, the transmitter 620 may be an example of aspects of the transceiver 835 described with reference to FIG. 8. The transmitter 620 may utilize a single antenna or a set of antennas.

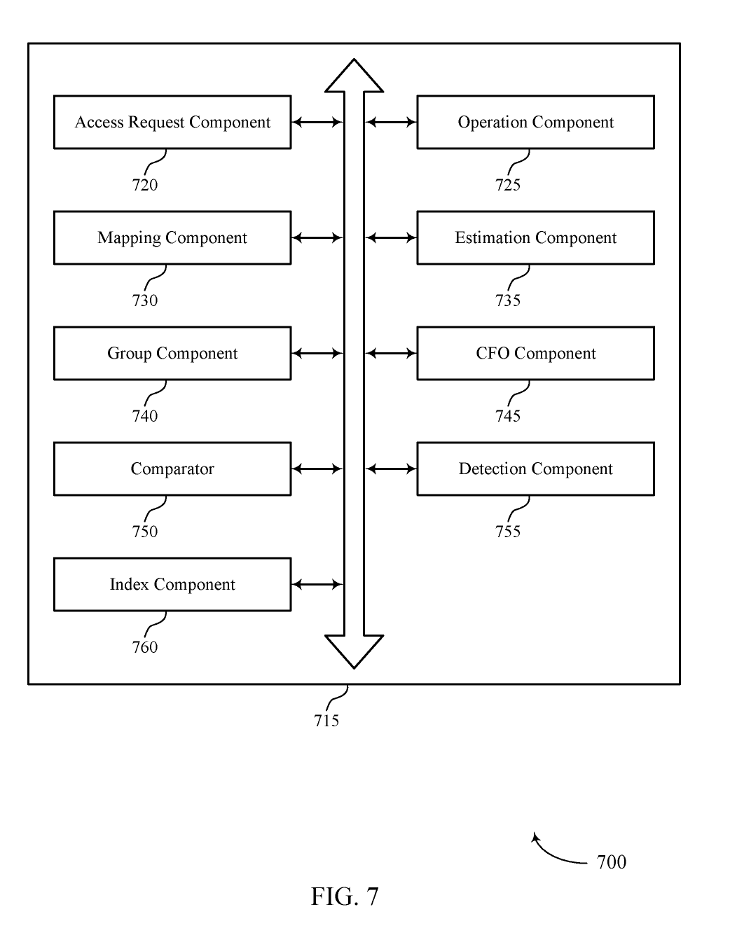

FIG. 7 shows a diagram 700 of a communications manager 715 that supports narrowband random access for wireless communications in accordance with aspects of the present disclosure. The communications manager 715 may be an example of aspects of a communications manager 515, a communications manager 615, or a communications manager 815 described with reference to FIGS. 5, 6, and 8. The communications manager 715 may include access request component 720, operation component 725, mapping component 730, estimation component 735, group component 740, CFO component 745, comparator 750, detection component 755, and index component 760. Each of these modules may communicate, directly or indirectly, with one another (e.g., via one or more buses).

Access request component 720 may receive, at a base station from a UE, an access request including an identification of a set of sets of symbol groups. In some cases, the identification of the set of sets of symbol groups includes: a first format of the access request, the first format having a first CP length, or a second format of the access request, the second format having a second CP length longer than the first CP length.

Operation component 725 may perform a set of differential operations for each set of symbol groups.

Mapping component 730 may map each differential operation to a corresponding accumulator of a set of accumulators.

Estimation component 735 may estimate an RTD time between the UE and the base station based on the mapped differential operations and divide the set of accumulators into a first group of accumulators and a second group of accumulators, where the first group of accumulators conveys a dominant portion of phase information associated with the access request and the second group of accumulators conveys phase disambiguation information. Estimation component 735 may calculate the RTD time based on the first group of accumulators and the second group of accumulators. In some cases, estimating the RTD time includes: frequency correcting each of the set of accumulators based on the estimated CFO term.

Group component 740 may compute an intra-symbol group average for each symbol group of a set of symbol groups, where each differential operation for the set of symbol groups is mapped based on intra-symbol group averages of two symbol groups of the set of symbol groups.

CFO component 745 may estimate a CFO term based on the mapped differential operations, where the RTD time is estimated based on the estimated CFO term and perform a coarse offset estimation, where a range of unambiguous frequency offsets associated with the fine CFO estimation is increased based on the coarse offset estimation. In some cases, estimating the CFO term includes: performing a fine CFO estimation based on a differential of a first accumulator of the set of accumulators and a second accumulator of the set of accumulators. In some cases, for each set of the plurality of sets of symbol groups, a first differential operation of the set of differential operations is mapped to one of the first accumulator or the second accumulator based on an initial tone for a first symbol group of the set of symbols groups. In some cases, for each set of the plurality of sets of symbol groups, a second differential operation of the set of differential operations is mapped to the other of the first accumulator or the second accumulator based on the initial tone for the first symbol group of the set of symbols groups.

Comparator 750 may compare a function of the first group of accumulators and the second group of accumulators to a threshold.

Detection component 755 may detect a presence of the access request based on the comparison.

Index component 760 may identify a sub-carrier index sequence of a set of symbol groups, where each differential operation for the set of symbol groups is mapped based on the sub-carrier index sequence. In some cases, each sub-carrier index sequence includes: an initial tone for a first symbol group of the set of symbol groups and respective tones for each subsequent symbol group of the set of symbol groups, the respective tones being based on the initial tone and an inner hopping sequence. In some cases, the initial tone is based on a pseudo-random outer hopping sequence.

FIG. 8 shows a diagram of a system 800 including a device 805 that supports narrowband random access for wireless communications in accordance with aspects of the present disclosure. Device 805 may be an example of or include the components of wireless device 505, wireless device 605, or a base station 105 as described above, e.g., with reference to FIGS. 5 and 6. Device 805 may include components for bi-directional voice and data communications including components for transmitting and receiving communications, including communications manager 815, processor 820, memory 825, software 830, transceiver 835, antenna 840, network communications manager 845, and inter-station communications manager 850. These components may be in electronic communication via one or more buses (e.g., bus 810). Device 805 may communicate wirelessly with one or more UEs 115.

Processor 820 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 820 may be configured to operate a memory array using a memory controller. In other cases, a memory controller may be integrated into processor 820. Processor 820 may be configured to execute computer-readable instructions stored in a memory to perform various functions (e.g., functions or tasks supporting narrowband random access for wireless communications).

Memory 825 may include random access memory (RAM) and read only memory (ROM). The memory 825 may store computer-readable, computer-executable software 830 including instructions that, when executed, cause the processor to perform various functions described herein. In some cases, the memory 825 may contain, among other things, a basic input/output system (BIOS) which may control basic hardware or software operation such as the interaction with peripheral components or devices.

Software 830 may include code to implement aspects of the present disclosure, including code to support narrowband random access for wireless communications. Software 830 may be stored in a non-transitory computer-readable medium such as system memory or other memory. In some cases, the software 830 may not be directly executable by the processor but may cause a computer (e.g., when compiled and executed) to perform functions described herein.

Transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas.

In some cases, the wireless device may include a single antenna 840. However, in some cases the device may have more than one antenna 840, which may be capable of concurrently transmitting or receiving multiple wireless transmissions.

Network communications manager 845 may manage communications with the core network (e.g., via one or more wired backhaul links). For example, the network communications manager 845 may manage the transfer of data communications for client devices, such as one or more UEs 115.

Inter-station communications manager 850 may manage communications with other base station 105, and may include a controller or scheduler for controlling communications with UEs 115 in cooperation with other base stations 105. For example, the inter-station communications manager 850 may coordinate scheduling for transmissions to UEs 115 for various interference mitigation techniques such as beamforming or joint transmission. In some examples, inter-station communications manager 850 may provide an X2 interface within an LTE/LTE-A or an NR wireless communication network technology to provide communication between base stations 105.

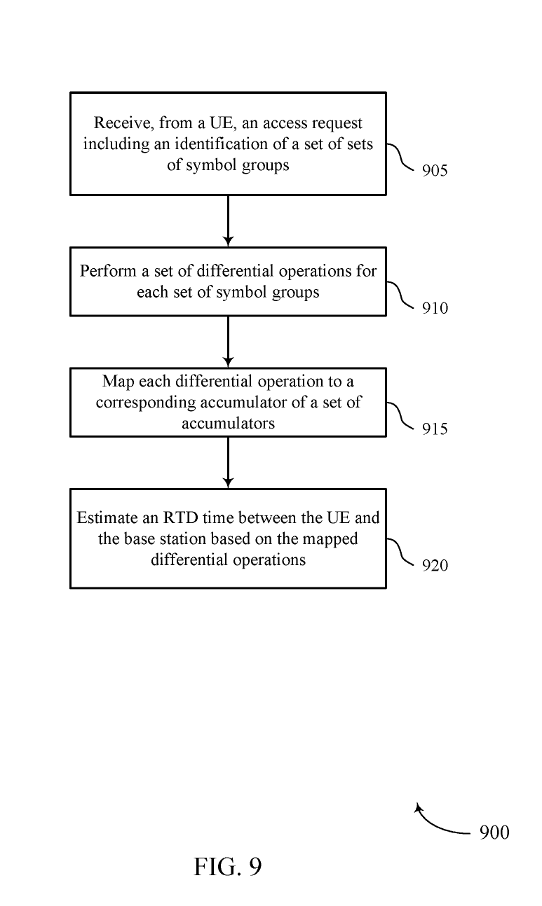

FIG. 9 shows a flowchart illustrating a method 900 for narrowband random access for wireless communications in accordance with aspects of the present disclosure. The operations of method 900 may be implemented by a base station 105 or its components as described herein. For example, the operations of method 900 may be performed by a communications manager as described with reference to FIGS. 5 through 8. In some examples, a base station 105 may execute a set of codes to control the functional elements of the device to perform the functions described below. Additionally or alternatively, the base station 105 may perform aspects of the functions described below using special-purpose hardware.

At block 905 the base station 105 may receive, at a base station from a UE, an access request including an identification of a plurality of sets of symbol groups. The operations of block 905 may be performed according to the methods described herein. In certain examples, aspects of the operations of block 905 may be performed by a access request component as described with reference to FIGS. 5 through 8.

At block 910 the base station 105 may perform a set of differential operations for each set of symbol groups. The operations of block 910 may be performed according to the methods described herein. In certain examples, aspects of the operations of block 910 may be performed by a operation component as described with reference to FIGS. 5 through 8.

At block 915 the base station 105 may map each differential operation to a corresponding accumulator of a plurality of accumulators. The operations of block 915 may be performed according to the methods described herein. In certain examples, aspects of the operations of block 915 may be performed by a mapping component as described with reference to FIGS. 5 through 8.

At block 920 the base station 105 may estimate an RTD time between the UE and the base station based at least in part on the mapped differential operations. The operations of block 920 may be performed according to the methods described herein. In certain examples, aspects of the operations of block 920 may be performed by a estimation component as described with reference to FIGS. 5 through 8.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as CDMA, TDMA, FDMA, OFDMA, single carrier FDMA (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of eNBs provide coverage for various geographical regions. For example, each eNB, next generation NodeB (gNB), or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein-including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
receiving, at a base station from a user equipment (UE), an access request including an identification of a plurality of sets of symbol groups;
performing a set of differential operations for each set of symbol groups;
mapping each differential operation to a corresponding accumulator of a plurality of accumulators; and
estimating an RTD time between the UE and the base station based at least in part on the mapped differential operations.

2. The method of claim 1, further comprising:
computing an intra-symbol group average for each symbol group of a set of symbol groups, wherein each differential operation for the set of symbol groups is mapped based at least in part on intra-symbol group averages of two symbol groups of the set of symbol groups.

3. The method of claim 1, further comprising:
estimating a carrier frequency offset (CFO) term based at least in part on the mapped differential operations, wherein the RTD time is estimated based at least in part on the estimated CFO term.

4. The method of claim 3, wherein estimating the CFO term comprises:
performing a fine CFO estimation based at least in part on a differential of a first accumulator of the plurality of accumulators and a second accumulator of the plurality of accumulators.

5. The method of claim 4, wherein, for each set of the plurality of sets of symbol groups:
a first differential operation of the set of differential operations is mapped to one of the first accumulator or the second accumulator based at least in part on an initial tone for a first symbol group of the set of symbols groups; and
a second differential operation of the set of differential operations is mapped to the other of the first accumulator or the second accumulator based at least in part on the initial tone for the first symbol group of the set of symbols groups.

6. The method of claim 4, further comprising:
performing a coarse offset estimation, wherein a range of unambiguous frequency offsets associated with the fine CFO estimation is increased based at least in part on the coarse offset estimation.

7. The method of claim 3, wherein estimating the RTD time comprises:
frequency correcting each of the plurality of accumulators based at least in part on the estimated CFO term;
dividing the plurality of accumulators into a first group of accumulators and a second group of accumulators, wherein the first group of accumulators conveys a dominant portion of phase information associated with the access request and the second group of accumulators conveys phase disambiguation information; and
calculating the RTD time based at least in part on the first group of accumulators and the second group of accumulators.

8. The method of claim 7, further comprising:
comparing a function of the first group of accumulators and the second group of accumulators to a threshold; and
detecting a presence of the access request based at least in part on the comparison.

9. The method of claim 1, further comprising:
identifying a sub-carrier index sequence of a set of symbol groups, wherein each differential operation for the set of symbol groups is mapped based at least in part on the sub-carrier index sequence.

10. The method of claim 9, wherein each sub-carrier index sequence comprises:
an initial tone for a first symbol group of the set of symbol groups; and
respective tones for each subsequent symbol group of the set of symbol groups, the respective tones being based at least in part on the initial tone and an inner hopping sequence.

11. The method of claim 10, wherein:
the initial tone is based at least in part on a pseudo-random outer hopping sequence.

12. The method of claim 1, wherein the identification of the plurality of sets of symbol groups comprises:
a first format of the access request, the first format having a first cyclic prefix (CP) length; or
a second format of the access request, the second format having a second CP length longer than the first CP length.

13. An apparatus for wireless communication, comprising:
means for receiving, at a base station from a user equipment (UE), an access request including an identification of a plurality of sets of symbol groups;
means for performing a set of differential operations for each set of symbol groups;
means for mapping each differential operation to a corresponding accumulator of a plurality of accumulators; and
means for estimating an RTD time between the UE and the base station based at least in part on the mapped differential operations.

14. The apparatus of claim 13, further comprising:
means for computing an intra-symbol group average for each symbol group of a set of symbol groups, wherein each differential operation for the set of symbol groups is mapped based at least in part on intra-symbol group averages of two symbol groups of the set of symbol groups.

15. The apparatus of claim 13, further comprising:
means for estimating a carrier frequency offset (CFO) term based at least in part on the mapped differential operations, wherein the RTD time is estimated based at least in part on the estimated CFO term.

16. The apparatus of claim 15, wherein the means for estimating the CFO term comprises:
means for performing a fine CFO estimation based at least in part on a differential of a first accumulator of the plurality of accumulators and a second accumulator of the plurality of accumulators.

17. The apparatus of claim 16, wherein, for each set of the plurality of sets of symbol groups:
a first differential operation of the set of differential operations is mapped to one of the first accumulator or the second accumulator based at least in part on an initial tone for a first symbol group of the set of symbols groups; and
a second differential operation of the set of differential operations is mapped to the other of the first accumulator or the second accumulator based at least in part on the initial tone for the first symbol group of the set of symbols groups.

18. The apparatus of claim 16, further comprising:
means for performing a coarse offset estimation, wherein a range of unambiguous frequency offsets associated with the fine CFO estimation is increased based at least in part on the coarse offset estimation.

19. The apparatus of claim 15, wherein the means for estimating the RTD time comprises:
means for frequency correcting each of the plurality of accumulators based at least in part on the estimated CFO term;
means for dividing the plurality of accumulators into a first group of accumulators and a second group of accumulators, wherein the first group of accumulators conveys a dominant portion of phase information associated with the access request and the second group of accumulators conveys phase disambiguation information; and
means for calculating the RTD time based at least in part on the first group of accumulators and the second group of accumulators.

20. The apparatus of claim 19, further comprising:
means for comparing a function of the first group of accumulators and the second group of accumulators to a threshold; and
means for detecting a presence of the access request based at least in part on the comparison.

21. An apparatus for wireless communication, comprising:
a processor;
memory in electronic communication with the processor; and
instructions stored in the memory and operable, when executed by the processor, to cause the apparatus to:
receive, at a base station from a user equipment (UE), an access request including an identification of a plurality of sets of symbol groups;
perform a set of differential operations for each set of symbol groups;
map each differential operation to a corresponding accumulator of a plurality of accumulators; and
estimate an RTD time between the UE and the base station based at least in part on the mapped differential operations.

22. The apparatus of claim 21, wherein the instructions are further executable by the processor to:
compute an intra-symbol group average for each symbol group of a set of symbol groups, wherein each differential operation for the set of symbol groups is mapped based at least in part on intra-symbol group averages of two symbol groups of the set of symbol groups.

23. The apparatus of claim 21, wherein the instructions are further executable by the processor to:
estimate a carrier frequency offset (CFO) term based at least in part on the mapped differential operations, wherein the RTD time is estimated based at least in part on the estimated CFO term.

24. The apparatus of claim 23, wherein:
estimating the CFO term comprises: performing a fine CFO estimation based at least in part on a differential of a first accumulator of the plurality of accumulators and a second accumulator of the plurality of accumulators.

25. The apparatus of claim 24, wherein, for each set of the plurality of sets of symbol groups:
a first differential operation of the set of differential operations is mapped to one of the first accumulator or the second accumulator based at least in part on an initial tone for a first symbol group of the set of symbols groups; and
a second differential operation of the set of differential operations is mapped to the other of the first accumulator or the second accumulator based at least in part on the initial tone for the first symbol group of the set of symbols groups.

26. The apparatus of claim 24, wherein the instructions are further executable by the processor to:
perform a coarse offset estimation, wherein a range of unambiguous frequency offsets associated with the fine CFO estimation is increased based at least in part on the coarse offset estimation.

27. The apparatus of claim 23, wherein:
estimating the RTD time comprises: frequency correcting each of the plurality of accumulators based at least in part on the estimated CFO term;
the instructions are further executable to divide the plurality of accumulators into a first group of accumulators and a second group of accumulators, wherein the first group of accumulators conveys a dominant portion of phase information associated with the access request and the second group of accumulators conveys phase disambiguation information; and
calculate the RTD time based at least in part on the first group of accumulators and the second group of accumulators.

28. The apparatus of claim 27, wherein the instructions are further executable by the processor to:
compare a function of the first group of accumulators and the second group of accumulators to a threshold; and
detect a presence of the access request based at least in part on the comparison.

29. A non-transitory computer readable medium storing code for wireless communication, the code comprising instructions executable by a processor to:
receive, at a base station from a user equipment (UE), an access request including an identification of a plurality of sets of symbol groups;
perform a set of differential operations for each set of symbol groups;
map each differential operation to a corresponding accumulator of a plurality of accumulators; and
estimate an RTD time between the UE and the base station based at least in part on the mapped differential operations.

30. The non-transitory computer-readable medium of claim 29, wherein the instructions are further executable by the processor to:
compute an intra-symbol group average for each symbol group of a set of symbol groups, wherein each differential operation for the set of symbol groups is mapped based at least in part on intra-symbol group averages of two symbol groups of the set of symbol groups.
